(19) United States
(12) Patent Application Publication
(10) Pub. No.: US 2025/0358058 A1
(43) Pub. Date: Nov. 20, 2025

(54) WIRELESS COMMUNICATION METHOD AND DEVICE THEREOF

(71) Applicant: ZTE CORPORATION, Shenzhen (CN)

(72) Inventors: Jiajun XU, Shenzhen (CN); Jianqiang DAI, Shenzhen (CN); Mengzhu CHEN, Shenzhen (CN); Bo DAI, Shenzhen (CN); Jun XU, Shenzhen (CN); Hong TANG, Shenzhen (CN); Xiaoying MA, Shenzhen (CN)

(73) Assignee: ZTE CORPORATION, Shenzhen (CN)

(21) Appl. No.: 19/281,279

(22) Filed: Jul. 25, 2025

Related U.S. Application Data
(63) Continuation of application No. PCT/CN2023/076856, filed on Feb. 17, 2023.

(51) Int. Cl. H04L 1/1867; H04L 1/1812; H04L 1/1822

(52) U.S. Cl. CPC H04L 1/1887; H04L 1/1812; H04L 1/1822; H04L 1/1896

(57) ABSTRACT

The present disclosure relates to method, systems and devices for wireless communication. The present disclosure relates to wireless communication method for use in a wireless terminal, the method comprising receiving, from a wireless network node, a control signaling, determining a plurality of time locations of a plurality of transmission occasions in a time duration based on a first equation using at least one first parameter indicated by the control signaling, and determining a plurality of hybrid automatic retransmission request (HARQ) process identifiers (IDs) for the transmission occasions in the time duration based on a second equation using at least one second parameter indicated by the control signaling.

### CROSS-REFERENCE TO RELATED PATENT APPLICATIONS

This application is a U.S. Bypass Continuation of International Application No. PCT/CN2023/076856 filed Feb. 17, 2023, incorporated herein by reference in its entirety.

### TECHNICAL FIELD

This document is directed generally to wireless communications, and in particular to a method for HARQ process identifier determination.

In beyond 5G and 6G communication, one of promising services is characterized by quasi-periodicity (jitter impact), large and various data amount and stringent latency requirement, including e.g., extended reality (XR) service. In prior arts, configured grant (CG) is capable of conveying periodic data by preconfigured resource without time consuming grant request.

### SUMMARY

In order to address the characteristic of large and variable packet size, multiple CG physical uplink shared channel (PUSCH) occasions in a period is considered for transmission.

This document relates to methods, systems, and devices for wireless communication.

The present disclosure relates to wireless communication method for use in a wireless terminal, the method comprising:
receiving, from a wireless network node, a control signaling,
determining a plurality of time locations of a plurality of transmission occasions in a time duration based on a first equation using at least one first parameter indicated by the control signaling, and
determining a plurality of hybrid automatic retransmission request (HARQ) process identifiers (IDs) for the transmission occasions in the time duration based on a second equation using at least one second parameter indicated by the control signaling.

Various embodiments may preferably implement the following features.

Preferably or in some embodiments, the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

Preferably or in some embodiments, the CG list includes at least one of: one or more CG configurations.

Preferably or in some embodiments, the HARQ process ID pattern pool includes one or more HARQ process ID patterns and the HARQ process ID pattern includes one or more HARQ process IDs.

Preferably or in some embodiments, the resource location information is used for determining the time locations of the transmission occasions in the time duration.

Preferably or in some embodiments, the resource location information includes at least one of: a length of the time duration, the time location information of the transmission occasions in the time duration, or a number of the transmission occasions.

Preferably or in some embodiments, the periodicity information is used for determining at least one of a length of the time duration, a first interval between two consecutive time durations, a second interval between 1st transmission occasions within two consecutive time durations, a third interval between two consecutive transmission occasions in the time duration, or a fourth interval between 1st symbols within two consecutive transmission occasions.

Preferably or in some embodiments, the time offset information includes a set of time offsets corresponding to the CG list,

Preferably or in some embodiments, a time unit of the time duration is one of a symbol, a slot, milliseconds, or a radio frame.

Preferably or in some embodiments, the transmission occasions are for a configured grant transmission.

Preferably or in some embodiments, the transmission occasions within two consecutive time durations of the configured grant transmission are periodical.

Preferably or in some embodiments, a repetition for the configured grant transmission is available if a value of a repetition parameter for the repetition is not larger than a value associated with the third interval between two consecutive transmission occasions in the time duration.

Preferably or in some embodiments, a repetition for the configured grant transmission is available if a value of a repetition parameter for the repetition is not larger than a value associated with a length of the time duration.

Preferably or in some embodiments, a repetition is unavailable for the configured grant transmission.

Preferably or in some embodiments, a configured grant based multiple transmit/receive point (mTRP) physical uplink shared channel (PUSCH) repetition is triggered by a plurality of parameter fields in the control signaling.

Preferably or in some embodiments, the parameter fields comprise at least one of: power control information, power control loop information, path loss reference information, sounding reference signal (SRS) resource information, precoding and multiple-input-multiple-output layer information, or redundancy version information.

Preferably or in some embodiments, the at least one first parameter comprises at least one of: a periodicity parameter, an offset parameter, a quantity parameter for a number of transmission occasions in the time duration, an index parameter, a system configuration parameter, or a start time parameter.

Preferably or in some embodiments, the index parameter is associated with an index for one of the transmission occasions, for the time duration or for 1st transmission occasion in the time duration.

Preferably or in some embodiments, the system configuration parameter indicates at least one of a number of slots in one radio frame, a number of symbols in a radio frame or an index of a staring radio frame of the time duration.

Preferably or in some embodiments, the start time parameter indicates at least one of a radio frame, a slot or a symbol of a 1st transmission occasion in the time duration.

Preferably or in some embodiments, the at least one first parameter comprises the periodicity parameter, the index parameter, the system configuration parameter, and the start time parameter.

Preferably or in some embodiments, the index parameter is associated with an index for the time duration or 1st transmission occasion in the time duration.

Preferably or in some embodiments, the at least one first parameter comprises the resource location information, the periodicity parameter, the quantity parameter, the time offset parameter, the index parameter, the system configuration parameter, and the start time parameter.

Preferably or in some embodiments, the quantity parameter is determined based on at least one of resource location information or periodicity information comprised in the control signaling.

Preferably or in some embodiments, the resource location information includes the time location information of the transmission occasions in the time duration by using a bitmap and the quantity parameter is a number of bits ‘1’ within the bitmap.

Preferably or in some embodiments, the resource location information includes the time location information of the plurality of transmission occasions in the time duration by using a length of the transmission occasions and the quantity parameter is the length of the transmission occasions.

Preferably or in some embodiments, the resource location information includes a number of the transmission occasions and the quantity parameter is the number of the transmission occasions.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the quantity parameter is the length of the time duration dividing the third interval or the fourth interval.

Preferably or in some embodiments, the periodicity information includes a first interval between two consecutive time durations, a second interval between 1st transmission occasions within two consecutive time durations.

Preferably or in some embodiments, the periodicity parameter is determined based on one of the first interval or the second interval, the index information and the quantity information comprised in the control signaling.

Preferably or in some embodiments, the time offset parameter is determined based on at least one of the resource location information, the periodicity information or the time offset information comprised in the control signaling.

Preferably or in some embodiments, the resource location information includes the time location information of the transmission occasions in the time duration by using a bitmap.

Preferably or in some embodiments, the time offset parameter is a set of bit distances between a 1st bit and each bit having the same value of the 1st bit in the bitmap.

Preferably or in some embodiments, the resource location information includes the time location information of the transmission occasions in the time duration by using a length of the transmission occasions.

Preferably or in some embodiments, the time offset parameter is a number of offsets ranging from 0 to the length of the transmission occasions minus 1.

Preferably or in some embodiments, the resource location information includes the number of the transmission occasions.

Preferably or in some embodiments, the time offset parameter is a number of offsets ranging from 0 to the number of the transmission occasions minus 1.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the time offset parameter is determined based on the number of transmission occasions, the index information and one of the third interval or the fourth interval.

Preferably or in some embodiments, the time offset information includes a set of time offsets corresponding to a CG list.

Preferably or in some embodiments, the time offset parameter is determined based on the set of time offsets.

Preferably or in some embodiments, the start time parameter is determined by time offset information comprised in the control signaling.

Preferably or in some embodiments, the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

Preferably or in some embodiments, the at least one second parameter comprises the parameter associated with the number of the HARQ Process IDs and the time locations of the transmission occasions determined based on the first equation.

Preferably or in some embodiments, the at least one second parameter comprises the parameter associated with a number of HARQ Process IDs, the periodicity parameter, the offset parameter and the time locations of the transmission occasions determined based on the first equation.

Preferably or in some embodiments, a number of HARQ process IDs are associated with the quantity parameter for the number of the transmission occasions.

Preferably or in some embodiments, the periodicity parameter is determined based on periodicity information comprised in the control signaling.

Preferably or in some embodiments, the periodicity information includes a first interval between two consecutive time durations, or a second interval between 1st transmission occasions within two consecutive time durations.

Preferably or in some embodiments, the periodicity parameter is the first interval or the second interval.

Preferably or in some embodiments, the periodicity information includes a third interval between two consecutive transmission occasions in the time duration, or a fourth interval between 1st symbols within two consecutive transmission occasions.

Preferably or in some embodiments, the periodicity parameter is the third interval or the fourth interval.

Preferably or in some embodiments, the offset parameter is determined based on at least one of resource location information, periodicity information or the time offset information comprised in the control signaling.

Preferably or in some embodiments, the resource location information includes the time location of the transmission occasions in the time duration by using a bitmap.

Preferably or in some embodiments, the offset parameter is determined based on a set of bit distances between a 1st bit and other bits having the same value with the 1st bit within the bitmap.

Preferably or in some embodiments, the resource location information includes the length of the transmission occasions.

Preferably or in some embodiments, the offset parameter is determined as a number of offsets ranging from 0 to the length of the transmission occasions minus 1.

Preferably or in some embodiments, the resource location information includes the number of the transmission occasions.

Preferably or in some embodiments, the offset parameter is determined as a number of offsets ranging from 0 to the number of the transmission occasions minus 1.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the offset parameter is determined based on the number of transmission occasions, the index information and one of the third interval or the fourth interval.

Preferably or in some embodiments, the time offset information includes a set of time offsets corresponding to a CG list.

Preferably or in some embodiments, the offset parameter is determined based on the set of time offsets.

Preferably or in some embodiments, determining the HARQ process IDs for the transmission occasions in the time duration based on the second equation using the at least one second parameter indicated by the control signaling comprises:
determining a first HARQ process ID for of 1st transmission occasion in the time duration based on the second equation using the at least one second parameter indicated by the control signaling, and
determining the HARQ process IDs of the remaining transmission occasions in the time duration based on the first HARQ process ID.

Preferably or in some embodiments, the HARQ process IDs of the remaining transmission occasions in the time duration are determined to be equal to the first HARQ process ID, or the HARQ process IDs of the remaining transmission occasions in the time duration are determined to be in an increasing order which is in time domain and starts from the first HARQ process ID.

The present disclosure further relates to a wireless communication method for use in a wireless network node, the method comprising:
transmitting, to a wireless terminal network node, a control signaling,
wherein the control signaling comprises at least one first parameter used for determining a plurality of time locations of a plurality of transmission occasions in a time duration based on a first equation, and
wherein the control signaling comprises at least one second parameter used for determining a plurality of hybrid automatic retransmission request (HARQ) process identifiers (IDs) for the transmission occasions in the time duration based on a second equation.

Various embodiments may preferably implement the following features.

Preferably or in some embodiments, the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

Preferably or in some embodiments, the CG list includes at least one of: one or more CG configurations.

Preferably or in some embodiments, the HARQ process ID pattern pool includes one or more HARQ process ID patterns and the HARQ process ID pattern includes one or more HARQ process IDs.

Preferably or in some embodiments, the resource location information is used for determining the time locations of the transmission occasions in the time duration.

Preferably or in some embodiments, the resource location information includes at least one of: a length of the time duration, the time location information of the transmission occasions in the time duration, or a number of the transmission occasions.

Preferably or in some embodiments, the periodicity information is used for determining at least one of a length of the time duration, a first interval between two consecutive time durations, a second interval between 1st transmission occasions within two consecutive time durations, a third interval between two consecutive transmission occasions in the time duration, or a fourth interval between 1st symbols within two consecutive transmission occasions.

Preferably or in some embodiments, the time offset information includes a set of time offsets corresponding to the CG list.

Preferably or in some embodiments, a time unit of the time duration is one of a symbol, a slot, milliseconds, or a radio frame.

Preferably or in some embodiments, the transmission occasions are for a configured grant transmission.

Preferably, the transmission occasions within two consecutive time durations of the configured grant transmission are periodical.

Preferably or in some embodiments, a repetition for the configured grant transmission is available if a value of a repetition parameter for the repetition is not larger than a value associated with an interval between two consecutive transmission occasions in the time duration.

Preferably or in some embodiments, a repetition for the configured grant transmission is available if a value of a repetition parameter for the repetition is not larger than a value associated with a length of the time duration.

Preferably or in some embodiments, a repetition is unavailable for the configured grant transmission.

Preferably or in some embodiments, a configured grant based multiple transmit/receive point (mTRP) physical uplink shared channel (PUSCH) repetition is triggered by a plurality of parameter fields in the control signaling.

Preferably or in some embodiments, the parameter fields comprise at least one of: power control information, power control loop information, path loss reference information, sounding reference signal (SRS) resource information, precoding and multiple-input-multiple-output layer information, or redundancy version information.

Preferably or in some embodiments, the at least one first parameter comprises at least one of: a periodicity parameter, an offset parameter, a quantity parameter for a number of transmission occasions in the time duration, an index parameter, a system configuration parameter, or a start time parameter.

Preferably or in some embodiments, the index parameter is associated with an index for one of the transmission occasions, for the time duration or for 1st transmission occasion in the time duration.

Preferably or in some embodiments, the system configuration parameter indicates at least one of a number of slots in one radio frame, a number of symbols in a radio frame or an index of a staring radio frame of the time duration.

Preferably or in some embodiments, the start time parameter indicates at least one of a radio frame, a slot or a symbol of a 1st transmission occasion in the time duration.

Preferably or in some embodiments, the at least one first parameter comprises the periodicity parameter, the index parameter, the system configuration parameter, and the start time parameter.

Preferably or in some embodiments, the index parameter is associated with an index for the time duration or 1st transmission occasion in the time duration.

Preferably or in some embodiments, the at least one first parameter comprises the resource location information, the periodicity parameter, the quantity parameter, the time offset parameter, the index parameter, the system configuration parameter, and the start time parameter.

Preferably or in some embodiments, the quantity parameter is determined based on at least one of resource location information or periodicity information comprised in the control signaling.

Preferably or in some embodiments, the resource location information includes the time location information of the transmission occasions in the time duration by using a bitmap and the quantity parameter is a number of bits ‘1’ within the bitmap.

Preferably or in some embodiments, the resource location information includes the time location information of the plurality of transmission occasions in the time duration by using a length of the transmission occasions and the quantity parameter is the length of the transmission occasions.

Preferably or in some embodiments, the resource location information includes a number of the transmission occasions and the quantity parameter is the number of the transmission occasions.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the quantity parameter is the length of the time duration dividing the third interval or the fourth interval.

Preferably or in some embodiments, the periodicity information includes a first interval between two consecutive time durations, a second interval between 1st transmission occasions within two consecutive time durations.

Preferably or in some embodiments, the periodicity parameter is determined based on one of the first interval or the second interval, the index information and the quantity information comprised in the control signaling.

Preferably or in some embodiments, the time offset parameter is determined based on at least one of the resource location information, the periodicity information or the time offset information comprised in the control signaling.

Preferably or in some embodiments, the resource location information includes the time location information of the transmission occasions in the time duration by using a bitmap.

Preferably or in some embodiments, the time offset parameter is a set of bit distances between a 1st bit and each bit having the same value of the 1st bit in the bitmap.

Preferably or in some embodiments, the resource location information includes the time location information of the transmission occasions in the time duration by using a length of the transmission occasions.

Preferably or in some embodiments, the time offset parameter is a number of offsets ranging from 0 to the length of the transmission occasions minus 1.

Preferably or in some embodiments, the resource location information includes the number of the transmission occasions.

Preferably or in some embodiments, the time offset parameter is a number of offsets ranging from 0 to the number of the transmission occasions minus 1.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the time offset parameter is determined based on the number of transmission occasions, the index information and one of the third interval or the fourth interval.

Preferably or in some embodiments, the time offset information includes a set of time offsets corresponding to a CG list.

Preferably or in some embodiments, the time offset parameter is determined based on the set of time offsets.

Preferably or in some embodiments, the start time parameter is determined by time offset information comprised in the control signaling.

Preferably or in some embodiments, the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

Preferably or in some embodiments, the at least one second parameter comprises the parameter associated with the number of the HARQ Process IDs and the time locations of the transmission occasions determined based on the first equation.

Preferably or in some embodiments, the at least one second parameter comprises the parameter associated with a number of HARQ Process IDs, the periodicity parameter, the offset parameter and the time locations of the transmission occasions determined based on the first equation.

Preferably or in some embodiments, a number of HARQ process IDs are associated with the quantity parameter for the number of the transmission occasions.

Preferably or in some embodiments, the periodicity parameter is determined based on periodicity information comprised in the control signaling.

Preferably or in some embodiments, the periodicity information includes a first interval between two consecutive time durations, or a second interval between 1st transmission occasions within two consecutive time durations.

Preferably or in some embodiments, the periodicity parameter is the first interval or the second interval.

Preferably or in some embodiments, the periodicity information includes a third interval between two consecutive transmission occasions in the time duration, or a fourth interval between 1st symbols within two consecutive transmission occasions.

Preferably or in some embodiments, the periodicity parameter is the third interval or the fourth interval.

Preferably or in some embodiments, the offset parameter is determined based on at least one of resource location information, periodicity information or the time offset information comprised in the control signaling.

Preferably or in some embodiments, the resource location information includes the time location of the transmission occasions in the time duration by using a bitmap.

Preferably or in some embodiments, the offset parameter is determined based on a set of bit distances between a 1st bit and other bits having the same value with the 1st bit within the bitmap.

Preferably or in some embodiments, the resource location information includes the length of the transmission occasions.

Preferably or in some embodiments, the offset parameter is determined as a number of offsets ranging from 0 to the length of the transmission occasions minus 1.

Preferably or in some embodiments, the resource location information includes the number of the transmission occasions.

Preferably or in some embodiments, the offset parameter is determined as a number of offsets ranging from 0 to the number of the transmission occasions minus 1.

Preferably or in some embodiments, the periodicity information includes at least one of a length of the time duration, a third interval between two consecutive transmission occasions in the time duration, or a fourth interval between 1st symbols within two consecutive transmission occasions.

Preferably or in some embodiments, the offset parameter is determined based on the number of transmission occasions, the index information and one of the third interval or the fourth interval.

Preferably or in some embodiments, the time offset information includes a set of time offsets corresponding to a CG list.

Preferably or in some embodiments, the offset parameter is determined based on the set of time offsets.

The present disclosure further relates to a wireless terminal, comprising:
a communication unit, configured to receive, from a wireless network node, a control signaling, and
a processor, configured to:
determine a plurality of time locations of a plurality of transmission occasions in a time duration based on a first equation using at least one first parameter indicated by the control signaling, and
determine a plurality of hybrid automatic retransmission request (HARQ) process identifiers (IDs) for the transmission occasions in the time duration based on a second equation using at least one second parameter indicated by the control signaling.

According to various embodiments, the processor is preferably further configured to perform the wireless communication method described above.

The present disclosure further relates to a wireless network node, comprising:
a communication unit, configured to transmit, to a wireless terminal network node, a control signaling,
wherein the control signaling comprises at least one first parameter used for determining a plurality of time locations of a plurality of transmission occasions in a time duration based on a first equation, and
wherein the control signaling comprises at least one second parameter used for determining a plurality of hybrid automatic retransmission request (HARQ) process identifiers (IDs) for the transmission occasions in the time duration based on a second equation.

According to various embodiments, the processor is preferably further configured to perform the wireless communication method described above.

### DETAILED SPECIFICATION

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a configured grant transmission according to an embodiment of the present disclosure.

FIG. 3 shows an example of a schematic diagram of a wireless terminal according to an embodiment of the present disclosure.

FIG. 4 shows an example of a schematic diagram of a wireless network node according to an embodiment of the present disclosure.

FIG. 5 shows a flow chart of a method according to an embodiment of the present disclosure.

FIG. 6 shows a flow chart of a method according to an embodiment of the present disclosure.

### DETAILED DESCRIPTION

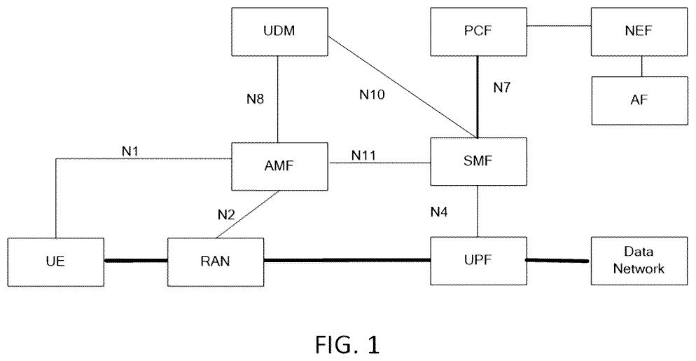

FIG. 1 shows a schematic diagram of a network (architecture) according to an embodiment of the present disclosure. In FIG. 1, the network comprises the following network functions/entities:
1) UE: User Equipment
2) RAN: Radio Access Network

In the present disclosure, the RAN may be equal to RAN node or next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.
5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.
7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.
9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

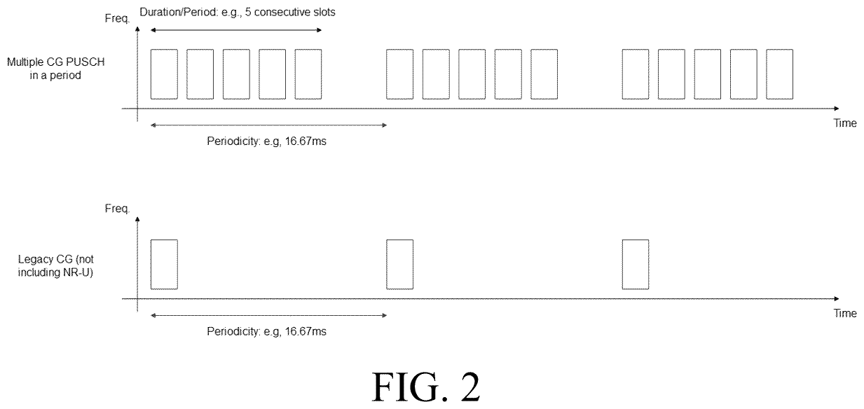

As shown in FIG. 2, there may be multiple CG PUSCH occasions in a CG period. That is there are more than one CG PUSCH in a period compared to legacy CG configuration where only one CG PUSCH is in single period.

For legacy CG configuration, once CG is activated, the gNB would allocate the CG PUSCHs to the UE according to configured parameters (e.g., RRC parameters) and scheduling parameters (e.g., time domain allocation, frequency domain allocation, MCS level and etc.) in activation signaling (RRC or DCI).

In an embodiment, a procedure for configuring a CG can be divided briefly as the following:
Step 0: Parameter configuration
Step 1: Transmission occasion determination
Step 2: HARQ (Hybrid Automatic Repeat Request) Process ID determination
Step 3: Resource configuration

In the above procedure, Step 1 and Step 2 are determined by configured parameters, while Step 3 is determined by scheduling parameters.

Regarding the transmission occasions determination, all available transmission occasions are numbered and their symbol/slot location can be derived by:

### Type 1 CG (RRC Activation)

After an uplink grant is configured for a configured grant Type 1, the MAC entity shall consider sequentially that the Nth (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot )$$

### Type 2 CG (DCI Activation)

After an uplink grant is configured for a configured grant Type 2, the MAC entity shall consider sequentially that the Nth (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot ) .$$

According to the time domain location of the transmission occasions, the HARQ process ID for each transmission occasion.

For configured uplink grants neither configured with harq-ProcID-Offset2 nor with cg-RetransmissionTimer, the HARQ Process ID associated with the first symbol of a UL transmission is derived from the following equation:

$$HARQ Process ID = [ floor ( CURRENT\_symbol / periodicity ) ] modulo nrofHARQ - Processes$$

For configured uplink grants with harq-ProcID-Offset2, the HARQ Process ID associated with the first symbol of a UL transmission is derived from the following equation:

$$HARQ Process ID = [ floor ( CURRENT\_symbol / periodicity ) ] modulo nrofHARQ - Processes + harq - ProcID - Offset 2$$

The “CURRENT_symbol” is the result for transmission occasion determination formula.

In an embodiment for the configuration of multiple CG PUSCH occasions in single CG period, the transmission occasion calculation equation may be modified, e.g., based on the transmission occasion calculation equation for the configuration of only one CG PUSCH in single CG period. In this embodiment, the HARQ Process ID for the multiple CG PUSCH occasions in single CG period may be determined by a HARQ Process ID calculation equation, e.g., modified based on the HARQ Process ID calculation equation for the configuration of only one CG PUSCH in single CG period. As an alternative, the HARQ Process ID for the multiple CG PUSCH occasions in single CG period may be determined by using the HARQ Process ID calculation equation for the configuration of only one CG PUSCH in single CG period and a corresponding rule. For example, the corresponding rule may be that the HARQ Process ID of each CG PUSCH in a CG period is same with that of the first (1^{st}) CG PUSCH in the CG period. Or, the corresponding rule may be that the HARQ Process IDs of the CG PUSCHs in a CG period are monotonically increased starting from that of the first (1^{st}) CG PUSCH in the CG period.

In an embodiment for the configuration of multiple CG PUSCH occasions in single CG period, the transmission occasion calculation equation may be similar to, e.g., the transmission occasion calculation equation for the configuration of only one CG PUSCH in single CG period. In this embodiment, the HARQ Process ID for the multiple CG PUSCH occasions in single CG period may be determined by a HARQ Process ID calculation equation, e.g., modified based on the HARQ Process ID calculation equation for the configuration of only one CG PUSCH in single CG period. As an alternative, the HARQ Process ID for the multiple CG PUSCH occasions in single CG period may be determined by using the HARQ Process ID calculation equation for the configuration of only one CG PUSCH in single CG period and a corresponding rule. For example, the corresponding rule may be that the HARQ Process ID of each CG PUSCH in a CG period is same with that of the first (1^{st}) CG PUSCH in the CG period. Or, the corresponding rule may be that the HARQ Process IDs of the CG PUSCHs in a CG period are monotonically increased starting from that of the first (1^{st}) CG PUSCH in the CG period.

In an embodiment, Pre-defined HARQ process ID patterns for the transmission occasions in a CG period are configured in the RRC signaling. The UE may determine one of HARQ process ID patterns for the configuration based on the DCI signaling.

In an embodiment, a network device (e.g., UE) receives a control signaling from a network node (e.g., gNB), determines a time location of one or more transmission occasions based on a first equation by using at least one first parameter determined based on the control signaling, and determines a hybrid automatic retransmission request (HARQ) process identifier (ID) for each transmission occasion based on a second equation by using at least one second parameter determined based on the control signaling.

The following items would be further discussed in the subsequent embodiments:
The control signaling
The transmission occasion
The method of a time location of a transmission occasion determination
The method of a HARQ process ID of a transmission occasion determination

### Control Signaling

In some embodiments, the control signaling is/comprises at least one of:
High layer parameter: For example, the high layer parameter may be a radio resource control (RRC) signaling (e.g., ConfiguredGrantConfig) or a MAC CE signaling; or
Downlink control information (DCI) signaling: For instance, the DCI signaling is for a configured grant transmission activation.

As an alternative, the control signaling is RRC signaling ConfiguredGrantConfig.

As an alternative, the control signaling is RRC signaling ConfiguredGrantConfig and DCI signaling for configured grant transmission occasions activation.

In some embodiments, the control signaling comprises/carries resource location information (e.g., the at least one first parameter for determining the time location of the one or more transmission occasions in single time duration (e.g., CG period) and/or the at least one second parameter for determining the HARQ process IDs of the one or more transmission occasions in single time duration).

In some embodiments, the resource control signaling comprises at least one of:
resource location information;
periodicity information;
time offset information;
scheduling information;
configured grant list; or
HARQ process ID pattern pool.

In an embodiment, the resource location information is used for determining the time location of a transmission occasion in a time duration.

In an embodiment, the resource location information includes at least one of: a length of the time duration, a time location information of transmission occasions in one time duration, or a number of the transmission occasions.

In an embodiment, the time duration is a number of symbols, a number of slots, a number of milliseconds, or a number of radio frames.

In some cases, the time location information of transmission occasion in one time duration is a bitmap. The bit within the bitmap denotes a symbol or a slot in the time duration.

In an embodiment, the bit ‘1’ in the bitmap determines/indicates that the starting symbol of the transmission occasion locates in the corresponding symbol/slot and the bit ‘0’ determines the starting symbol of the transmission occasion does not locate in the corresponding symbol/slot.

As an alternative, the bit ‘0’ in the bitmap determines/indicates that the starting symbol of the transmission occasion locates in the corresponding symbol/slot, while the bit ‘1’ determines/indicates that the starting symbol of the transmission occasion does not locate in the corresponding symbol/slot.

In some cases, the time location information of transmission occasion in one time duration is a length of transmission occasions. In this case, the starting symbols of the transmission occasions in one time duration are located consecutively in several symbols/slots.

In some cases, the time location information of transmission occasions in one time duration is a starting and length indication value (SLIV), on which the length of the transmission occasions can be derived based. In this case, the starting symbols of the transmission occasions in one time duration are located consecutively in several symbols/slots.

In an embodiment, the number of transmission occasions indicates the quantity of the transmission occasions in one time duration.

In an embodiment, the periodicity information is used for determining the length of the time duration in symbol/slot/millisecond/radio frame level.

In an embodiment, the periodicity information is used for determining a first interval between two consecutive time durations in symbol/slot/millisecond/radio frame level.

In some cases, the first interval is the distance between the last symbol of the previous/former time duration (of the two consecutive time durations) and the first (1st) symbol of the latter time duration (of the two consecutive time durations) in symbol/slot/millisecond/radio frame level.

In some cases, the first interval is the distance between the first (1st) symbol of the previous/former time duration (of the two consecutive time durations) and the first (1st) symbol of the latter time duration (of the two consecutive time durations) in symbol/slot/millisecond/radio frame level.

In an embodiment, the periodicity information is used for determining a second interval between the first (1st) transmission occasion of two consecutive time durations in symbol/slot/millisecond/radio frame level.

In some cases, the second interval is the distance between the last symbol of the first (1st) transmission occasion in the previous/former time duration (of the two consecutive time durations) and the first (1st) symbol of the first transmission occasion in the latter time duration in symbol/slot level.

In some cases, the second interval is the distance between the first (1st) symbol of the first (1st) transmission occasion in the previous/former time duration (of the two consecutive time durations) and the first (1st) symbol of the first (1st) transmission occasion in the latter time duration (of the two consecutive time durations) in symbol/slot level.

In an embodiment, the periodicity information is used for determining a third interval between the two consecutive transmission occasions in one time duration in symbol/slot/millisecond/radio frame level.

In some cases, the third interval is the distance between the last symbol of the previous/former transmission occasion (of the two transmission occasions) in the time duration and the first (1st) symbol of the later transmission occasion (of the two transmission occasions) in the time duration.

In an embodiment, the periodicity information is used for determining a fourth interval between the first (1st) symbols within two consecutive transmission occasions.

In some cases, the fourth interval is the distance between the first (1st) symbol of the previous/former transmission occasion (of the two transmission occasions) in the time duration and the first (1st) symbol of the later transmission occasion (of the two transmission occasions) in the time duration.

In an embodiment, the time offset information is/indicates the interval between activation signaling and the first (1st) transmission occasion in symbol/slot/millisecond/radio frame level.

In an embodiment, the time offset information is/indicates the interval between referent radio frame and the first (1st) transmission occasion in symbol/slot/millisecond/radio frame level, where the defined radio frame is determined by the control signaling.

In an embodiment, the time offset information is/indicates a set of time offsets (in symbol/slot level) corresponding to the CG list.

In some cases, the set of time offsets includes a plurality of time offsets value, each value corresponds to a specific CG configuration within the CG list.

For example, there are 4 time offsets values in slot level within the set of time offsets, {0, 1, 2, 3}, which corresponds to 4 CG configurations within the CG list, respectively, i.e., 0-th time offset is for the 0-th CG configuration, and so on.

As an alternative, the set of time offsets is a sequence of timeDomainOffset for CG Type 1.

In an embodiment, the scheduling information comprises/indicates at least one of time/frequency occupation information, modulation and coding scheme, or the number of layers.

In an embodiment, the CG list includes one or more CG configurations, where the CG configurations within the CG list share some parameters, including e.g., frequency hopping, demodulation reference signaling (DMRS) configuration, a number of HARQ processes, resource allocation type, MCS (modulation and coding scheme) table, periodicity and etc., while some parameters are different among CG configuration in CG list, including at least time domain offset, indicating the interval between the referent radio frame and the first transmission occasion in symbol/slot/millisecond/radio frame level or between activation signaling and the first transmission occasion in symbol/slot/millisecond/radio frame level.

In an embodiment, the HARQ process ID pattern pool includes one or more HARQ process ID patterns and the HARQ process ID patterns includes one or more HARQ process IDs.

In some cases, the HARQ process ID pattern pool is predefined in control signaling, e.g., ConfiguredGrantConfig.

For example, The HARQ process ID pattern pool is pre-defined in the RRC signaling ConfiguredGrantConfig.

| Entry | HARQ Process ID pattern |
|---|---|
| 0 | 0 |
| 1 | [0 1] |
| 2 | [1 0] |
| 3 | [0 1 2] |
| 4 | [1 0 2] |
| 5 | [2 1 0] |
| 6 | [0 1 2 3] |
| 7 | [1 0 2 3] |
| . . . | . . . |

In above table, different HARQ Process ID patterns are applicable for different configured grant transmissions.

For example, the HARQ process ID pattern of Entry 1 and Entry 2 can be applicable for configured grant transmission with two transmission occasions in one time duration.

In an embodiment, the HARQ process ID within the HARQ process ID pattern corresponds to the HARQ process ID of a specific transmission occasion.

For example, if the HARQ process ID pattern of Entry 1 is selected, the HARQ process ID of the first (1st) transmission occasion in one time duration is assigned by 0, while the HARQ process ID of the second (2nd) transmission occasion in one time duration is assigned by 1.

In some cases, the entry selection within the pre-defined HARQ process ID pattern pool is determined by a DCI (downlink control information) signaling, such as DCI signaling format 0_1, 0_2, which is used for configured grant activation.

### Transmission Occasion

In some embodiments, there is (only) one transmission occasion in the time duration and the transmission occasion is for the configured grant transmission.

In an embodiment, the transmission occasion is periodic and the time location is determined by the first relation/equation.

In some embodiments, there are a plurality of transmission occasions in single time duration and the transmission occasions are for the configured grant transmission.

In an embodiments, the plurality of transmission occasions in single time duration for configured grant transmission are determined by the number of transmission occasions within resource location information and one of the third interval or the fourth interval within periodicity information.

In an embodiment, the time durations are periodic and the time location is determined by the first equation/relationship.

In an embodiment, a repetition for the configured grant transmission may be implemented as one of the following cases:

In a case, the repetition is not available.

In a case, the repetition is available. In this case, the repetition transport block is transmitted in the subsequent symbols or slots behind the transmission occasion if the parameter for repetition is configured and if a condition is meet. For example, the condition may be that the value of the parameter for repetition is not larger than the value of periodicity information using for determining the interval between two consecutive transmission occasions in one time duration.

In a case, the repetition is available. In this case, the repetition transport block is transmitted in the transmission occasions if the parameter for repetition is configured and if a condition is met. For instance, the condition may be that the value of parameter for repetition is not larger than the value of the length of the time duration determined by periodicity information or the resource information.

In a case, for configured grant based multiple transmit/receive point (mTRP) physical uplink shared channel (PUSCH) repetition (triggered by the control signaling), a second field for configured grant configuration is introduced. The second field includes at least one of:
power control information;
power control loop information;
path loss reference information;
SRS resource information;
precoding and MIMO layer information; or
redundancy version information;

### Method of Determining a Time Location of a Transmission Occasion

In some embodiments, the time locations of the transmission occasion(s) are determined by the first equation/relationship.

In an embodiment, the first equation/relationship is associated with at least one first parameter comprising at least one of:
a periodicity parameter (denoted by P);
an offset parameter (denoted by K);
a quantity parameter for the number of transmission occasions in one/single time duration (denoted by Np);
An index parameter (denoted by N);
a system configuration parameter;
a start time parameter.

In an embodiment, the index parameter N is associated with the index for the transmission occasion(s).

In an embodiment, the index parameter N is associated with the index for the time duration.

In an embodiment, the system configuration parameter includes at least one of: the number of slots in one radio frame, the number of symbols in one radio frame, or an index of a staring radio frame (e.g., for the transmission occasion(s)).

In an embodiment, the start time parameter is associated with the radio frame, slot and symbol for the first (1^{st}) transmission occasion (e.g., in the time duration).

In an embodiment, the first equation/relationship is associated with the P (periodicity parameter), Np (quantity parameter for a number of transmission occasions in one time duration), K (the offset parameter), N (the index parameter), the system configuration parameter, and the start time parameter.

In an embodiment, the Np, quantity parameter for (indicating) the number of transmission occasions in one time duration is determined by at least one of: the resource location information and/or periodicity information.

In an embodiment, the time location information of the transmission occasion(s) in one time duration within the resource location information is (indicated by) a bitmap. In this embodiment, Np is the number of bits ‘1’ or bit ‘0’ within the bitmap.

For example, if the bitmap is ‘110011’, if Nₚ is the number of bits ‘1’ within the bitmap, Nₚ is 4. As an alternative, if Nₚ is the number of bits ‘0’, Nₚ is 2.

In an embodiment, the time location information of transmission occasion(s) in one time duration within the resource location information is the length L of consecutive transmission occasions. Under such conditions, Nₚ is configured as L, i.e., Nₚ=L.

In an embodiment, the resource location information includes the number of the transmission occasions. Under such conditions, Nₚ is configured as the value of the number of the transmission occasions.

In an embodiment, the periodicity information includes one of the third interval between the two consecutive transmission occasions in one time duration or the fourth interval between the first symbols within two consecutive transmission occasions, which is denoted by P₂. In this case, Np=operator1(D/P₂), where D is the length of the time duration, which is determined by the resource location information or by the periodicity information, and operator1(*) is/includes one of the following: ceiling operator, flooring operator, or rounding operator.

In an embodiment, the periodicity parameter P is determined by/based on periodicity information.

As an alternative, the periodicity parameter P=periodicity, where the periodicity is the first interval, the second interval or the length of the time duration.

As an alternative, the periodicity parameter P=operator1(N,Nₚ)×periodicity, where operator1(*) is/includes one of the following: ceiling operator, flooring operator, or rounding operator.

In an embodiment, the offset parameter K is determined by at least one of: the resource location information, the periodicity information and the time offset information.

In an embodiment, the time location information of the transmission occasion in one time duration is (indicated by) a bitmap in the resource location information. In this embodiment, the offset parameter K is an offset set including a plurality of distances between the first bit and other bits, which are indicating the same value. In an embodiment, the Kᵢ within offset parameter K may indicate the distance between the first equal bit ‘1’/‘0’ and the i-th equal bit ‘1’/‘0’. In other words, in this embodiment, Kᵢ within the offset parameter K is a distance/interval between the first (0-th) bit ‘1’/‘0’ and the i-th bit ‘1’/‘0’.

Therein, K={Kᵢ}, i=operator2(N,Nₚ).

In an embodiment, operator2 is a modulo operator.

For example, for a bitmap ‘10011’, K={0,3,4}, where K₀=0, K₁=3, K₂=4.

In an embodiment, the periodicity information includes the third interval or the fourth interval, which denoted by P₂., the offset parameter K=operator2(N,Nₚ)×P₂.

In an embodiment, the time location information of a transmission occasion in one time duration in the resource location information is (indicated by) the length L of transmission occasions, the offset parameter K is an offset set comprising the value ranging from 0 to the length of transmission occasion minus 1, i.e., K={i}, i=0, 1, 2, . . . , L−1

In an embodiment, resource location information includes the number of the transmission occasions in one time duration, the offset parameter K is an offset set comprising the value ranging from 0 to the number of transmission occasion minus 1, i.e., K={i}, i=0, 1, 2, . . . , Nₚ−1.

In an embodiment, resource location information includes the number of the transmission occasions in one time duration, the offset parameter K=operator2(N, Nₚ)×operator1(D/Np), where D is the length of time duration which is determined by resource information or by periodicity information.

In an embodiment, the start time parameter is determined by the time offset information.

In an embodiment, for configured grant Type 1, the first equation/relationship represents that the N-th (N>=0) uplink grant occurs in symbol level for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + k + P ) modulo ( 1024 \times numberOfSlotsPerFrame \times numberOfSymbolsPerSlot )$$

Where, k∈K or k=K.

In an embodiment, for configured grant Type 1, the first equation/relationship represents that the N-th (N>=0) uplink grant occurs in slot for which:

$$[ ( SFN \times numberOfSlotsPerFrame ) + slot number in the frame ] = ( timeReferenceSFN \times numberOfSlotsPerFrame + timeDomainOffset + k + P ) modulo ( 1024 \times numberOfSlotsPerFrame )$$

In an embodiment, for configured grant Type 2, the first equation/relationship represents that the N-th (N>=0) uplink grant occurs in symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( {SFN}_{start time} \times numberOfSlotsPerFrame \times numberOfSymbolsPerSlot + {slot}_{start time} \times numberOfSymbolsPerSlot + {symbol}_{start time} + k ) + P ] modulo ( 1024 \times numberOfSlotsPerFrame \times numberOfSymbolsPerSlot )$$

In an embodiment, for configured grant Type 2, the first equation/relationship represents that the N-th (N>=0) uplink grant occurs in slot for which:

$$[ ( SFN \times numberOfSlotsPerFrame ) + slot number in the frame ] = [ ( {SFN}_{start time} \times numberOfSlotsPerFrame + {slot}_{start time} + k ) + P ] modulo ( 1024 \times numberOfSlotsPerFrame )$$

For example, if a time duration is configured to 28 symbols and the time location of first occasion is a bitmap, e.g., ‘1000000100000010000001000000’, K can be a set {0, 7, 14, 21}, k=Kᵢ, i=floor (N, Nₚ). Nₚ is 4, which is derived from the bitmap, i.e., it can be obtained by calculating the number of bits ‘1’.

For another example, if the third interval or the fourth interval is P₂=7 (7 symbols) and the number of the transmission occasions in one time duration is 4, i.e., Nₚ=4.

In an embodiment:

For CG Type 1:

The Nth (N>=0) first occasion occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + k + P ) modulo ( 1024 \times numberOfSlotsPerFrame \times numberOfSymbolsPerSlot )$$

For CG Type 2:

The Nth (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ \text{} ( {SFN}_{start time} \times numberOfSlotsPerFrame \times numberOfSymbolsPerSlot + {slot}_{start time} \times numberOfSymbolsPerSlot + symbolstart time + k ) + P ] modulo ( 1024 \times numberOfSlotsPerFrame \times numberOfSymbolsPerSlot )$$

Wherein, K can be associated with the third interval or the fourth interval, i.e., k=K=mod(N, Nₚ)×P₂, and P=floor(N, Nₚ)×periodicity.

In an embodiment, the first equation/relationship is associated with the periodicity parameter, the index parameter, the system configuration parameter, and the start time parameter. In this embodiment, the index parameter may be for the time duration or for the first (1st) transmission occasion in one time duration.

In an embodiment, for configured grant Type 1, the first equation/relationship represents that one of the N-th (N>=0) time duration or the starting symbol of the first (1st) transmission occasion within the N-th time duration occurs in symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot )$$

In an embodiment, for configured grant Type 1, the first equation/relationship represents that one of the N-th (N>=0) time duration or the starting slot of the first (1st) transmission occasion within the N-th time duration occurs in slot for which:

$$[ ( SFN \times numberOfSlotsPerFrame ) + slot number in the frame ] = ( timeReferenceSFN \times numberOfSlotsPerFrame + timeDomainOffset + N \times periodicity ) modulo ( 1024 \times numberOfSlotsPerFrame )$$

In an embodiment, for configured grant Type 2, the first equation/relationship represents that one of the N-th (N>=0) time duration or the starting symbol of the first (1st) transmission occasion within the N-th time duration in symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ \text{} ( {SFN}_{start time} \times numberOfSlotsPerFrame \times numberOfSymbolsPerSlot + {slot}_{start time} \times numberOfSymbolsPerSlot + {symbol}_{start time} ) + N \times periodicity ] modulo ( 1024 \times numberOfSlotsPerFrame \times numberOfSymbolsPerSlot )$$

In an embodiment, for configured grant Type 2, the first equation/relationship represents that one of the N-th (N>=0) time duration or the starting slot of the first (1st) transmission occasion within the N-th time duration occurs in slot for which:

$$[ ( SFN \times numberOfSlotsPerFrame ) + slot number in the frame ] = [ \text{} ( {SFN}_{start time} \times numberOfSlotsPerFrame + {slot}_{start time} ) + N \times periodicity ) modulo ( 1024 \times numberOfSlotsPerFrame )$$

### Method of Determining a Harq Process ID of a Transmission Occasion

In some embodiments, the HARQ process ID of the transmission occasion is determined by a second equation/relationship.

In an embodiment, the second equation/relationship is associated with at least one second parameter comprising at least one of:
a parameter for a number of HARQ Process IDs (denoted by nrofHARQ-Processes);
a periodicity parameter (denoted by P);
an offset parameter (denoted by J); or
a time domain location of the transmission occasion, which is determined by the first equation/relationship

In some embodiments, HARQ process ID of the transmission occasion is determined by the second equation and a third relationship based on the first (1^{st}) transmission occasion in one time duration.

In an embodiment, the number of HARQ process IDs is associated with at least one of the length of the time duration or the time location information of the first transmission occasion in the time duration, the number of the transmission occasions in the time duration.

In some cases, the number of HARQ process IDs is equal to the number of the transmission occasions in the time duration.

In an embodiment, the at least one second parameter comprises:
a number of HARQ Process IDs;
the time domain location of the transmission occasions determined by the first equation/relationship.

In this case, the second parameter further comprise the periodicity parameter P, where P=periodicity

In this embodiment, the HARQ process IDs of the transmission occasions are determined by the second equation/relationship or a third equation/relationship.

In this embodiment, determining the HARQ process IDs for the transmission occasions in the time duration based on the second equation using the at least one second parameter indicated by the control signaling comprises:

In this embodiment, the HARQ process ID for the first (1^{st}) transmission occasion in one time duration is determined by the second equation/relationship and the HARQ process IDs the remaining transmission occasions in the same time duration are determined by the third relationship.

In an embodiment, the HARQ Process ID associated with the first symbol of a first UL transmission in the time duration is derived from the following second equation:

$$HARQ Process ID = [ floor ( CURRENT\_slot / periodicity ) ] modulo nrofHARQ - Processes ( + harq - ProcID - Offset 2 )$$

In an embodiment, the third relationship is/includes: HARQ process IDs of the remaining transmission occasions in the time duration are determined to be equal to the first HARQ process ID, implying a common configuration where the HARQ process ID of the remaining transmission occasions in the time duration is the same as the 1^{st} transmission occasion in the same time duration,

In an embodiment, the third relationship is/includes: an increase configuration where the HARQ process IDs of the transmission occasions in the time duration are increased subsequently based on the HARQ process ID of 1^{st} transmission occasion in the same time duration.

In this case, the step for increasing HARQ process ID can be a positive integer, including e.g., 1, 2, 3, . . . and so on.

As an alternative, the final HARQ process ID of the transmission occasion is the increasing HARQ process ID.

For example, if the HARQ process ID of the first transmission occasion in one time duration is assigned by 1, the final HARQ process IDs of the remaining 3 transmission occasions are assigned by 2, 3, 4, respectively, assuming the step for increasing is 1, when the number of HARQ process IDs is 2.

As an alternative, the final HARQ process ID of the transmission occasion is result of the increasing HARQ process ID modulo the number of HARQ process ID.

For example, if the HARQ process ID of the first transmission occasion in one time duration is assigned by 1, the increasing HARQ process IDs of the remaining 3 transmission occasions are assigned by 2, 3, 4, respectively, assuming the step for increasing is 1. While the final HARQ process IDs of the remaining 3 transmission occasions are assigned by 2, 1, 2, respectively, when the number of HARQ process IDs is 2.

In some embodiments, the HARQ process ID of the transmission occasion is determined by the second relationship.

In an embodiment, when the second relationship is associated with the parameter for a number of HARQ Process IDs, the periodicity parameter, the offset parameter and the time domain location of the transmission occasion, the following may apply.

In an embodiment, the periodicity parameter P is determined by the periodicity information.

In an embodiment, the periodicity information includes one of the first interval or the second interval. Then, P=periodicity.

In an embodiment, periodicity information includes one of the third interval or the fourth interval which is denoted by P₂. Then, P=P₂.

In an embodiment, the offset parameter J is determined by at least one of: the time location information in the resource location information, the periodicity information, or the number of the transmission occasions in one period.

As an alternative, the offset parameter J comprised in the second parameter is the offset parameter K comprised in the first parameter. The K determination is mentioned above.

As an alternative, the offset parameter J is an offset set comprising the value ranging from 0 to the number of transmission occasion minus 1, i.e., J={t}, t=0, 1, 2, . . . , Nₚ−1. The Nₚ determination is mentioned above.

In an embodiment, the HARQ Process ID associated with the first symbol of a UL transmission is derived from the following second equation

$$HARQ Process ID = [ floor ( CURRENT\_symbol / P ) ] modulo nrofHARQ - Processes ( + harq - ProcID - Offset 2 ) , or \\ HARQ Process ID = [ floor ( CURRENT\_symbol / P ) + t ] modulo nrofHARQ - Processes ( + harq - ProcID - Offset 2 )$$

Where t∈J, or t=J

In an embodiment, the HARQ process IDs of the transmission occasions in one time duration are determined by DCI signaling, such as DCI format 0_1, DCI format 0_2 for configured grant activation.

In an embodiment, the HARQ process IDs of the transmission occasions are determined by CG-UCI.

Some examples are shown as follow:

In some embodiments, control signaling includes resource location information, periodicity information, time offset information, scheduling information associated with the plurality of transmission occasions in the time duration.

In some cases, the resource location information includes the time location information of the transmission occasions in the time duration, or includes the time location information of the transmission occasions in the time duration and a length of the period. The periodicity information includes one of the first interval between two consecutive time durations or the second interval between 1st transmission occasions within two consecutive time durations. And time offset information is the interval between referent radio frame and the first transmission occasion in slot level. The uplink grant is configured for a configured grant Type 1.

As an alternative, the time location information of the transmission occasions in the time duration is using by a bitmap in symbol level. Then the N-th (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + k + opeator 1 ( N , {N}_{p} ) \times periodicity ) modulo ( 1024 \times numberOfSlotsPerFrame \times numberOfSymbolsPerSlot ) ,$$

where k=Kᵢ∈K. i=operator2(N, Nₚ), Nₚ is the number of bit ‘1’ or the number of bit ‘0’ within the bitmap.

System configuration parameter numberOfSlotsPerFrame, numberOfSymbolsPerSlot and SFN are a number of slots in one radio frame, a number of symbols in a radio frame and an index of a staring radio frame of the time duration, respectively.

timeDomainOffset is determined by time offset information. And S is derived from the scheduling information, including e.g., SLIV or startSymsbol.

Then, the HARQ process ID associated with the first symbol of a UL transmission is derived from the following second equation:

$$HARQ Process ID = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process ID = [ floor ( CURRENT\_symbol / periodicity ) + t ] modulo nrofHARQ - Processes ( + harq - ProcID - Offset 2 ) ,$$

where t belongs to the offset sets J, J={t}, t=0, 1, 2, . . . , Nₚ−1. Or where t=k. And the CURRENT_symbol is calculated by the first equation.

As an alternative, the time location information of the transmission occasions in the time duration is using by a bitmap in slot level. Then the N-th (N>=0) uplink grant occurs in the slot for which:

$$[ ( SFN \times numberOfSlotsPerFrame ) + ( slot number in the frame ) ] = ( timeReferenceSFN \times numberOfSlotsPerFrame + timeDomainOffset + k + opeator 1 ( N , {N}_{p} ) \times periodicity ) modulo ( 1024 \times numberOfSlotsPerFrame ) ,$$

where k=Kᵢ∈K. i=operator2(N, Nₚ). Nₚ is the number of bit ‘1’ or the number of bit ‘0’ within the bitmap.

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + t ] modulo nrofHARQ - Processes ( + harq - ProcID - Offset 2 ) ,$$

where t belongs to the offset sets J, J={t}, t=0, 1, 2, . . . , Nₚ−1. Or where t=k. And the CURRENT_slot is calculated by the first equation.

As an alternative, the time location information of the transmission occasions in the time duration is using by a length of transmission occasions, which means the transmission occasions are occurred consecutively in symbol level in a time duration. Then the N-th (N>=0) uplink grant occurs in symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + i + operator 1 ( N , {N}_{p} ) \times periodicity ) modulo ( 1024 \times numberOfSlotsPerFrame \times numberOfSymbolsPerSlot ) ,$$

where K={i}, assuming the length of the transmission occasions is L, i=0, 1, 2, 3, . . . , L−1. Nₚ=L.

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the time location information of the transmission occasions in the time duration is using by a length of transmission occasions, which means the transmission occasions are occurred consecutively in slot level in a time duration. Then the N-th (N>=0) uplink grant occurs in symbol for which:

$$[ ( SFN \times numberOfSlotsPerFrame ) + ( slot number in the frame ) ] = ( timeReferenceSFN \times numberOfSlotsPerFrame + timeDomainOffset + i + operator 1 ( N , {N}_{p} ) \times periodicity ) modulo ( 1024 \times numberOfSlotsPerFrame ) ,$$

where K={i}, assuming the length of the transmission occasions is L, i=0, 1, 2, 3, . . . , L−1. Nₚ=L.

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 ) ,$$

where CURRENT_slot is calculated by the first equation.

Or, the HARQ Process ID associated with the slot of a UL transmission is derived from the following second equation:

$$HARQ Process I D = [ floor ( CURRENT\_slot / periodicity ) + t ] modulo nrofHARQ - Processes ( + harq - ProcID - Offset 2 ) ,$$

where t=i, i=0, 1, 2, . . . , L−1. And the CURRENT_slot is calculated by the first equation.

In some cases, the resource location information includes the time location information of the transmission occasions in the time duration, or includes the time location information of the transmission occasions in the time duration and a length of the period. The periodicity information includes one of the first interval between two consecutive time durations or the second interval between 1st transmission occasions within two consecutive time durations. And time offset information is the time interval between control signaling and the first transmission occasion in slot level. The uplink grant is configured for a configured grant Type 2 or for a configured grant Type 3.

As an alternative, the time location information of the transmission occasions in the time duration is using by a bitmap in symbol level. Then the N-th (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time + k ) + operator 1 ( N , {N}_{p} ) \times periodicity ) modulo ( 1024 \times numberOfSlotsPerFrame \times numberOfSymbolsPerSlot ) .$$

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 )$$

As an alternative the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t belongs to the offset sets J, J={t}, t=0, 1, 2, . . . , Nₚ−1. Or where t=k. And the CURRENT_symbol is calculated by the first equation.

As an alternative, the time location information of the transmission occasions in the time duration is using by a bitmap in slot level. Then the N-th (N>=0) uplink grant occurs in the slot for which:

$$[ ( SFN \times numberOfSlotsPerFrame ) + ( slot number in the frame ) ] = [ ( SFNstart time \times numberOfSlotsPerFrame + slotstart time + k ) + operator 1 ( N , {N}_{p} ) \times periodicity ] modulo ( 1024 \times numberOfSlotsPerFrame ) .$$

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 ) .$$

where CURRENT_slot is calculated by the first equation.

As an alternative, the HARQ Process ID associated with the slot of a UL transmission is derived from the following second equation:

$$HARQ Process I D = [ floor ( CURRENT\_slot / periodicity ) + t ] modulo nrofHARQ - Processes ( + harq - ProcID - Offset 2 ) ,$$

where t belongs to the offset sets J, J={t}, t=0, 1, 2, . . . , Nₚ−1. Or where t=k. And the CURRENT_slot is calculated by the first equation.

As an alternative, the time location information of the transmission occasions in the time duration is using by a length of the transmission occasions. Then the N-th (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time + i ) + operator 1 ( N , {N}_{p} ) \times periodicity ] modulo ( 1024 \times numberOfSlotsPerFrame \times numberOfSymbolsPerSlot ) .$$

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the time location information of the transmission occasions in the time duration is using by a length of the transmission occasions. Then the N-th (N>=0) uplink grant occurs in the slot for which:

$$[ ( SFN \times numberOfSlotsPerFrame ) + ( slot number in the frame ) ] = [ ( SFNstart time \times numberOfSlotsPerFrame + slotstart time + i ) + operator 1 ( N , {N}_{p} ) \times periodicity ] modulo ( 1024 \times numberOfSlotsPerFrame ) .$$

where K={i}, assuming the length of the transmission occasions is L, i=0, 1, 2, 3, . . . , L−1. Nₚ=L.

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 )$$

Where CURRENT_slot is calculated by the first equation.

As an alternative, the HARQ Process ID associated with the slot of a UL transmission is derived from the following second equation:

$$HARQ Process I D = [ floor ( CURRENT\_slot / periodicity ) + t ] modulo nrofHARQ - Processes ( + harq - ProcID - Offset 2 ) ,$$

where t=i, i=0, 1, 2, . . . , L−1. And the CURRENT_slot is calculated by the first equation.

In some cases, the resource location information includes the number of the transmission occasions in the time duration. The periodicity information includes one of the first interval between two consecutive time durations or the second interval between 1st transmission occasions within two consecutive time durations, and one of the third interval or the fourth interval. And time offset information is the interval between referent radio frame and the first transmission occasion in slot level. The uplink grant is configured for a configured grant Type 1.

As an alternative, the number of the transmission occasions in the time duration is Np, and the periodicity information includes the first/second interval and the third/fourth interval, where the first/second interval and the third/fourth interval are in symbol level. Then the N-th (N>=0) uplink grant occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = [ ( timeReferenceSFN \times numberOfSlotsPerFrame \times numberOfSymbolsPerSlot + timeDomainOffset \times numberOfSymbolsPerSlot + S + operator 2 ( N , {N}_{p} ) \times {P}_{2} + operator 1 ( N , {N}_{p} ) \times periodicity ) modulo ( 1024 \times numberOfSlotsPerFrame \times numberOfSymbolsPerSlot ) ,$$

where periodicity parameter comprises periodicity and P₂, P₂ is the value of the third interval or the fourth interval. The quantity number Nₚ is the number of the transmission occasions included in resource location information.

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the HARQ process ID associated with the first symbol of a UL transmission is derived from the following second equation:

$$HARQ Process I D = [ floor ( CURRENT\_symbol / {P}_{2} ) ] modulo nrofHARQ - Processes ( + harq - ProcID - Offset 2 ) .$$

As an alternative, the number of the transmission occasions in the time duration is Np, and the periodicity information includes the first/second interval and the third/fourth interval, where the first/second interval and the third/fourth interval are in slot level. Then the N-th (N>=0) uplink grant occurs in the slot for which

$$[ ( SFN \times numberOfSlotsPerFrame ) + slot number in the frame ] = ( timeReferenceSFN \times numberOfSlotsPerFrame + timeDomainOffset ) + operator 2 ( N , {N}_{p} ) \times {P}_{2} + operator 1 ( N , {N}_{p} ) \times periodicity ) modulo ( 1024 \times numberOfSlotsPerFrame ) .$$

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 ) .$$

where CURRENT_slot is calculated by the first equation.

As an alternative, the HARQ Process ID associated with the slot of a UL transmission is derived from the following second equation:

$$HARQ Process I D = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative the HARQ process ID associated with the first symbol of a UL transmission is derived from the following second equation:

$$HARQ Process I D = [ floor ( CURRENT\_symbol / {P}_{2} ) ] modulo nrofHARQ - Processes ( + harq - ProcID - Offset 2 ) .$$

In some cases, the resource location information includes the number of the transmission occasions in the time duration. The periodicity information includes one of the first interval between two consecutive time durations or the second interval between 1st transmission occasions within two consecutive time durations, and one of the third interval or the fourth interval. And time offset information is the time interval between control signaling and the first transmission occasion in slot level. The uplink grant is configured for a configured grant Type 2 or for a configured grant Type 3.

As an alternative, the number of the transmission occasions in the time duration is Nₚ, and the periodicity information includes the first/second interval and the third/fourth interval, where the first/second interval and the third/fourth interval are in symbol level. Then the N-th (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time + operator 2 ( N , {N}_{p} ) \times {P}_{2} ) + operator 1 ( N , {N}_{p} ) \times periodicity ] modulo ( 1024 \times numberOfSlotsPerFrame \times numberOfSymbolsPerSlot ) .$$

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative the HARQ process ID associated with the first symbol of a UL transmission is derived from the following second equation:

$$HARQ Process I D = [ floor ( CURRENT\_symbol / {P}_{2} ) ] modulo nrofHARQ - Processes ( + harq - ProcID - Offset 2 ) .$$

As an alternative, the number of the transmission occasions in the time duration is Nₚ, and the periodicity information includes the first/second interval and the third/fourth interval, where the first/second interval and the third/fourth interval are in slot level. Then the N-th (N>=0) uplink grant occurs in the slot for which:

$$[ ( SFN \times numberOfSlotsPerFrame ) + slot number in the frame ] = [ ( SFNstart time \times numberOfSlotsPerFrame ) + slotstart time + operator 2 ( N , {N}_{p} ) \times {P}_{2} + operator 1 ( N , {N}_{p} ) \times periodicity ] modulo ( 1024 \times numberOfSlotsPerFrame ) .$$

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process I D = [ floor ( CURRENT\_slot / periodicity ) + i ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ process ID associated with the first symbol of a UL transmission is derived from the following second equation:

$$HARQ Process I D = [ floor ( CURRENT\_symbol / {P}_{2} ) ] modulo nrofHARQ - Processes ( + harq - ProcID - Offset 2 ) .$$

In some cases, the resource location information includes the number of the transmission occasions in the time duration and the length of the duration. The periodicity information includes one of the first interval between two consecutive time durations or the second interval between 1st transmission occasions within two consecutive time durations. And time offset information is the interval between referent radio frame and the first transmission occasion in slot level. The uplink grant is configured for a configured grant Type 1.

As an alternative, the number of the transmission occasions in the time duration is Nₚ, the length of the duration is in symbol level and the periodicity information includes the first/second interval, where the first/second interval are in symbol level. Then the N-th (N>=0) uplink grant occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + operator 2 ( N , {N}_{p} ) \times floor ( D / {N}_{p} ) + operator 1 ( N , {N}_{p} ) \times periodicity ) modulo ( 1024 \times numberOfSlotsPerFrame \times numberOfSymbolsPerSlot ) ,$$

where D denotes the length of the duration, Nₚ is the number of the transmission occasions.

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the HARQ Process ID associated with the first symbol of a UL transmission is derived from the following second equation:

$$HARQ Process I D = [ floor ( CURRENT\_symbol / {P}_{2} ) ] modulo nrofHARQ - Processes ( + harq - ProcID - Offset 2 ) .$$

where P₂=floor (D/Nₚ).

As an alternative, the number of the transmission occasions in the time duration is Nₚ, the length of the duration is in slot level and the periodicity information includes the first/second interval, where the first/second interval are in slot level. Then the N-th (N>=0) uplink grant occurs in the slot for which

$$[ ( SFN \times numberOfSlotsPerFrame ) + ( slot number in the frame ) ] = ( timeReferenceSFN \times numberOfSlotsPerFrame ) + timeDomainOffset + operator 2 ( N , {N}_{p} ) \times floor ( D / {N}_{p} ) + operator 1 ( N , {N}_{p} ) \times periodicity ) modulo ( 1024 \times numberOfSlotsPerFrame ) ,$$

where D denotes the length of the duration, Nₚ is the number of the transmission occasions.

Then, the HARQ Process ID associated with the slot of a UL transmission is derived from the following second equation:

$$HARQ Process I D = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process I D = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process I D = [ floor ( CURRENT\_slot / {P}_{2} ) ] modulo nrofHARQ - Processes ( + harq - ProcID - Offset 2 ) .$$

where P₂=floor (D/Nₚ).

In some cases, the resource location information includes the number of the transmission occasions in the time duration and the length of the duration. The periodicity information includes one of the first interval between two consecutive time durations or the second interval between 1^{st} transmission occasions within two consecutive time durations. And time offset information is the time interval between control signaling and the first transmission occasion in slot level. The uplink grant is configured for a configured grant Type 2 or for a configured grant Type 3.

As an alternative, the number of the transmission occasions in the time duration is Np, the length of the duration is in symbol level and the periodicity information includes the first/second interval, where the first/second interval are in symbol level. Then the N-th (N>=0) uplink grant occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time + operator 2 ( N , {N}_{p} ) \times floor ( D / {N}_{p} ) ) + operator 1 ( N , {N}_{p} ) \times periodicity ] modulo ( 1024 \times numberOfSlotsPerFrame \times numberOfSymbolsPerSlot ) ,$$

where D denotes the length of the duration, Nₚ is the number of the transmission occasions.

Then, the HARQ process ID associated with the first symbol of a UL transmission is derived from the following second equation:

$$HARQ Process I D = [ floor ( CURRENT\_symbol / periodicity ) ] modulo nrofHARQ - Processes ( + harq - ProcID - Offset 2 ) .$$

As an alternative the HARQ process ID associated with the first symbol of a UL transmission is derived from the following second equation:

$$HARQ Process I D = [ floor ( CURRENT\_symbol / periodicity ) + t ] modulo nrofHARQ - Processes ( + harq - ProcID - Offset 2 ) .$$

where t=i, t=0, 1, 2, . . . , Nₚ−1. And the CURRENT_symbol is calculated by the first equation.

As an alternative, the HARQ process ID associated with the first symbol of a UL transmission is derived from the following second equation:

$$HARQ Process ID = [ floor ( CURRENT\_symbol / {P}_{2} ) ] modulo nrofHARQ - Processes ( + harq - ProcID - Offset 2 ) ,$$

where P₂=floor (D/Nₚ).

As an alternative, the number of the transmission occasions in the time duration is Nₚ, the length of the duration is in slot level and the periodicity information includes the first/second interval, where the first/second interval are in symbol level. Then the N-th (N>=0) uplink grant occurs in the symbol for which

$$[ ( SFN \times numberOfSlotsPerFrame ) + slot number in the frame ] = [ ( SFNstart time \times numberOfSlotsPerFrame + slotstart time + opeator 2 ( N , {N}_{p} ) \times floor ( D / {N}_{p} ) ) + opeator 1 ( N , {N}_{p} ) \times periodicity ] modulo ( 1024 \times numberOfSlotsPerFrame ) ,$$

where D denotes the length of the duration, Nₚ is the number of the transmission occasions.

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process ID = [ floor ( CURRENT\_slot / {P}_{2} ) ] modulo nrofHARQ - Processes ( + harq - ProcID - Offset 2 ) ,$$

where P₂=floor (D/Nₚ).

In some cases, the resource location information includes the length of the duration. The periodicity information includes one of the first interval between two consecutive time durations or the second interval between 1st transmission occasions within two consecutive time durations and one of the third interval and one of the fourth interval. And time offset information is the interval between referent radio frame and the first transmission occasion in slot level. The uplink grant is configured for a configured grant Type 1.

As an alternative, the length of the duration is in symbol level and the periodicity information includes the first/second interval and the third/fourth interval, where the first/second interval and the third/fourth interval are in symbol level. Then the N-th (N>=0) uplink grant occurs in the symbol for which

$$[ ( SFN \times numberOfSlotsPerFrame \times numberOfSymbolsPerSlot ) + ( slot number in the frame \times numberOdSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + opeator 2 ( N , {N}_{p} ) \times {P}_{2} + opeator 1 ( N , {N}_{p} ) \times periodicity ) modulo ( 1024 \times numberOfSlotsPerFrame \times numberOfSymbolsPerSlot ) ,$$

where Nₚ=floor (D/P₂), D denotes the length of the duration, P₂ is the third interval or the fourth interval.

Then, the HARQ process ID associated with the first symbol of a UL transmission is derived from the following second equation:

$$HARQ Process ID = [ floor ( CURRENT\_symbol / periodicity ) ] modulo nrofHARQ - Processes ( + harq - ProcID - Offset 2 ) .$$

As an alternative the HARQ process ID associated with the first symbol of a UL transmission is derived from the following second equation:

$$HARQ Process ID = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the HARQ process ID associated with the first symbol of a UL transmission is derived from the following second equation:

$$HARQ Process ID = [ floor ( CURRENT\_symbol / {P}_{2} ) ] modulo nrofHARQ - Processes ( + harq - ProcID - Offset 2 ) .$$

As an alternative, the length of the duration is in slot level and the periodicity information includes the first/second interval and the third/fourth interval, where the first/second interval and the third/fourth interval are in slot level. Then the N-th (N>=0) uplink grant occurs in the slot for which

$$[ ( SFN \times numberOfSlotsPerFrame ) + slot number in the frame ] = ( timeReferenceSFN \times numberOfSlotsPerFrame + timeDomainOffset + opeator 2 ( N , {N}_{p} ) \times {P}_{2} + opeator 1 ( N , {N}_{p} ) \times periodicity ) modulo ( 1024 \times numberOfSlotsPerFrame ) ,$$

where Nₚ=floor (D/P₂), D denotes the length of the duration, P₂ is the third interval of the fourth interval.

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process ID = [ floor ( CURRENT\_slot / {P}_{2} ) ] modulo nrofHARQ - Processes ( + harq - ProcID - Offset 2 ) ,$$

In some cases, the resource location information includes the length of the duration. The periodicity information includes one of the first interval between two consecutive time durations or the second interval between 1st transmission occasions within two consecutive time durations and one of the third interval and one of the fourth interval. And time offset information is the time interval between control signaling and the first transmission occasion in slot level. The uplink grant is configured for a configured grant Type 2 and for a configured grant Type 3.

As an alternative, the length of the duration is in symbol level and the periodicity information includes the first/second interval and the third/fourth interval, where the first/second interval and the third/fourth interval are in symbol level. Then the N-th (N>=0) uplink grant occurs in the symbol for which

$$[ ( SFN \times numberOfSlotsPerFrame \times numberOfSymbolsPerSlot ) + ( slot number in the frame \times numberOdSymbolsPerSlot ) + symbol number in the slot ] = [ ( SFNstart time \times numberOfSlotsPer Frame \times number OfSymbolsPerSlot + symbolstart time\_opeator 2 ( N , {N}_{p} ) \times {P}_{2} ) + opeator 1 ( N , {N}_{p} ) \times periodicity ] modulo ( 1024 \times numberOfSlotsPerFrame \times nuberOfSymbolsPerSlot ) .$$

where Nₚ=floor (D/P₂), D denotes the length of the duration, P₂ is the third interval or the fourth interval.

Then, the HARQ process ID associated with the first symbol of a UL transmission is derived from the following second equation:

$$HARQ Process ID = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process ID = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative the HARQ process ID associated with the first symbol of a UL transmission is derived from the following second equation:

$$HARQ Process ID = [ floor ( CURRENT\_symbol / {P}_{2} ) ] modulo nrofHARQ - Processes ( + harq - ProcID - Offset 2 ) .$$

As an alternative, the length of the duration is in slot level and the periodicity information includes the first/second interval and the third/fourth interval, where the first/second interval and the third/fourth interval are in slot level. Then the N-th (N>=0) uplink grant occurs in the slot for which

$$[ ( SFN \times numberOfSlotsPerFrame ) + slot number in the frame ] = [ SFNstart ti me \times numberOfSlotsPerFrame + slotstart time + opeator 2 ( N , {N}_{p} ) \times {P}_{2} ) + opeator 1 ( N , {N}_{p} ) \times periodicity ] modulo ( 1024 \times numberOfSlotsPerFrame \times numberOfSymbolsPerSlot ) ,$$

where Nₚ=floor (D/P₂), D denotes the length of the duration, P₂ is the third interval of the fourth interval.

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process ID = [ floor ( CURRENT\_slot / {P}_{2} ) ] modulo nrofHARQ - Processes ( + harq - ProcID - Offset 2 ) .$$

In some embodiments, the control signaling includes the periodicity information, time offset information, scheduling information associated with the plurality of transmission occasions in the time duration. And time offset information is the interval sets between referent radio frame and the first transmission occasion in slot level. The uplink grant is configured for a configured grant Type 1.

In some cases, the set of time offsets in slot level corresponds to CG configuration in the CG list. The N-th (N>=0) configured grant for the r-th CG configuration in the CG list occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = ( t imeReferenceSFN \times n umberOfSlotsPerFrame \times numberOfSymbolsPerSlot + {timeDomainOffset}_{r} \times numberOfSymbolsPerSlot + {S}_{r} + N \times periodicity ) modulo ( 1024 \times numberOfSlotsPerFrame \times numberOfSymbolsPerSlot ) ,$$

where timeDomainOffset, denotes the time offset in slot level of the r-th CG configuration within the time offset information, while S, denotes the starting symbol for the r-th CG configuration. r is an integer, r>=0.

Then, the HARQ process ID associated with the first symbol of a UL transmission of the r-th CG configuration is derived from the following second equation:

$$HARQ Process ID = [ floor ( CURRENT\_symbol / periodicity ) ] modulo nrofHARQ - Processes ( + harq - ProcID - Offset 2 ) .$$

In some cases, the time offset information includes a set of time offsets in slot level corresponding to CG configuration in the CG list. The N-th (N>=0) configured grant for the r-th CG configuration in the CG list occurs in the slot for which

$$[ ( SFN \times numberOfSlotsPerFrame ) + symbol number in the frame ] = ( t imeReferenceSFN \times n umberOfSlotsPerFrame + {timeDomainOffset}_{r} + N \times periodicity ) modulo ( 1024 \times numberOfSlotsPerFrame ) ,$$

where timeDomainOffset, denotes the time offset in slot level of the r-th CG configuration within the time offset information.

Then, the HARQ Process ID associated with the slot of a UL transmission of the r-th CG configuration is derived from the following second equation:

$$HARQ Process ID = [ floor ( CURRENT\_slot / periodicity ) ] modulo nrofHARQ - Processes ( + harq - ProcID - Offset 2 ) .$$

In some embodiments, the control signaling includes the periodicity information, time offset information, scheduling information associated with the plurality of transmission occasions in the time duration. And time offset information is the interval sets between control signaling and the first transmission occasion in slot level. The uplink grant is configured for a configured grant Type 2 or for a configured grant Type 3.

In some cases, the set of time offsets in symbol level corresponds to CG configuration in the CG list. The N-th (N>=0) configured grant for the r-th CG configuration in the CG list occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = ( SFNstart time \times n umberOfSlotsPerFrame \times numberOfSymbolsPerSlot + slotstart time \times numberOfSymbolsPerSlot + symbolstart time + {K}_{r} ) + N \times periodicity ] modulo ( 1024 \times numberOfSlotsPerFrame \times numberOfSymbolsPerSlot ) ,$$

where Kᵣ denotes the time offset in symbol level of the r-th CG configuration within the time offset information.

Then, the HARQ process ID associated with the first symbol of a UL transmission of the r-th CG configuration is derived from the following second equation:

$$HARQ Process ID = [ floor ( CURRENT\_symbol / periodicity ) ] modulo nrofHARQ - Processes ( + harq - ProcID - Offset 2 ) .$$

In some cases, the set of time offsets in slot level corresponds to CG configuration in the CG list. The N-th (N>=0) configured grant for the r-th CG configuration in the CG list occurs in the slot for which

$$[ ( SFN \times numberOfSlotsPerFrame ) + symbol number in the frame ] = ( SFNstart time \times n umberOfSlotsPerFrame + slotstart time + symbolstart time + {K}_{r} ) + N \times periodicity ] modulo ( 1024 \times numberOfSlotsPerFrame ) ,$$

where Kᵣ denotes the time offset in slot level of the r-th CG configuration within the time offset information.

Then, the HARQ Process ID associated with the slot of a UL transmission of the r-th CG configuration is derived from the following second equation:

$$HARQ Process ID = [ floor ( CURRENT\_slot / periodicity ) ] modulo nrofHARQ - Processes ( + harq - ProcID - Offset 2 ) .$$

In some embodiments, the control signaling includes the periodicity information, time offset information, scheduling information associated with the plurality of transmission occasions in the time duration. And time offset information is the interval between referent radio frame and the first transmission occasion in slot level. The uplink grant is configured for a configured grant Type 1.

In some cases, the first configured grant of the N-th (N>=0) time duration, or the N-th time duration, occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = ( t imeReferenceSFN \times n umberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot ) .$$

Then, the HARQ process ID associated with the first symbol of a UL transmission is derived from the following second equation:

$$HARQ Process ID = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process ID = [ floor ( CURRENT\_symbol / periodicity ) + t ] modulo nrofHARQ - Processes ( + harq - ProcID - Offset 2 ) ,$$

where t=i, t=0, 1, 2, . . . , Nₚ−1. And the CURRENT_symbol is calculated by the first equation.

As an alternative, the HARQ process ID associated with the first symbol of a UL transmission is derived from the following second equation:

$$HARQ Process ID = [ floor ( CURRENT\_symbol / {P}_{2} ] modulo nrofHARQ - Processes ( + harq - ProcID - Offset 2 ) .$$

In some cases, the first configured grant of the N-th (N>=0) time duration, or the N-th time duration, occurs in the slot for which

$$[ ( SFN \times numberOfSlotsPerFrame ) + slot number in the frame ] = ( timeReferenceSFN \times numberOfSymbolsPerSlot + timeDomainOffset + N \times periodicity ) modulo ( 1024 \times numberOfSlotsPerFrame ) .$$

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + t ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process ID = [ floor ( CURRENT\_slot / {P}_{2} ] modulo nrofHARQ - Processes ( + harq - ProcID - Offset 2 ) .$$

In some embodiments, the control signaling includes the periodicity information, time offset information, scheduling information associated with the plurality of transmission occasions in the time duration. And time offset information is the interval between control signaling and the first transmission occasion in slot level. The uplink grant is configured for a configured grant Type 2 or for a configured grant Type 3

In some cases, the first configured grant of the N-th (N>=0) time duration, or the N-th time duration, occurs in the symbol for which

$$[ ( SFN \times numberOfSlotsPerFrame \times numberOfSymbolsPerSlot ) + ( slot number in the frame \times numberOfSymbolsPerSlot ) + symbol number in the slot ] = [ ( SFN start time \times numberOfSlotsPerFrame \times numberOfSymbolsPerSlot + Slotstart time \times numberOfSymbolsPerSlot + symbolstart time ) + N \times periodicity ] modulo ( 1024 \times numberOfSlotsPerFrame \times numberOfSymbolsperSlot ) .$$

Then, the HARQ process ID associated with the first symbol of a UL transmission is derived from the following second equation:

$$HARQ Process ID = [ floor ( CURRENT\_symbol / periodicity ) ] modulo nrofHARQ - Processes ( + harq - ProcID - Offset 2 ) .$$

As an alternative, the HARQ process ID associated with the first symbol of a UL transmission is derived from the following second equation:

$$HARQ Process ID = [ floor ( CURRENT\_symbol / periodicity ) + i ] modulo nrofHARQ - Processes ( + harq - ProcID - Offset 2 ) ,$$

where t=i, t=0, 1, 2, . . . , Nₚ−1. And the CURRENT_symbol is calculated by the first equation.

Or the HARQ process ID associated with the first symbol of a UL transmission is derived from the following second equation:

$$HARQ Process ID = [ floor ( CURRENT\_symbol / {P}_{2} ] modulo nrofHARQ - Processes ( + harq - ProcID - Offset 2 ) .$$

In some cases, the first configured grant of the N-th (N>=0) time duration, or the N-th time duration, occurs in the slot for which

$$[ ( SFN \times numberOfSlotsPerFrame ) + slot number in the frame ] = [ ( SFN start time \times numberOfSlotsPerFrame + slotstart time ) + N \times periodicity ] modulo ( 1024 \times numberOfSlotsPerFrame )$$

Then, the HARQ Process ID associated with the slot of a UL transmission is derived from the following second equation:

$$HARQ Process ID = [ floor ( CURRENT\_slot / periodicity ) ] modulo nrofHARQ - Processes ( + harq - ProcID - Offset 2 ) ,$$

where CURRENT_slot is calculated by the first equation.

As an alternative, the HARQ Process ID associated with the slot of a UL transmission is derived from the following second equation:

$$HARQ Process ID = [ floor ( CURRENT\_slot / periodicity ) + i ] modulo nrofHARQ - Processes ( + harq - ProcID - Offset 2 ) ,$$

where t=i, t=0, 1, 2, . . . , Nₚ−1. And the CURRENT_slot is calculated by the first equation.

As an alternative, the HARQ Process ID associated with the slot of a UL transmission is derived from the following second equation:

$$HARQ Process ID = [ floor ( CURRENT\_slot / {P}_{2} ] modulo nrofHARQ - Processes ( + harq - ProcID - Offset 2 ) .$$

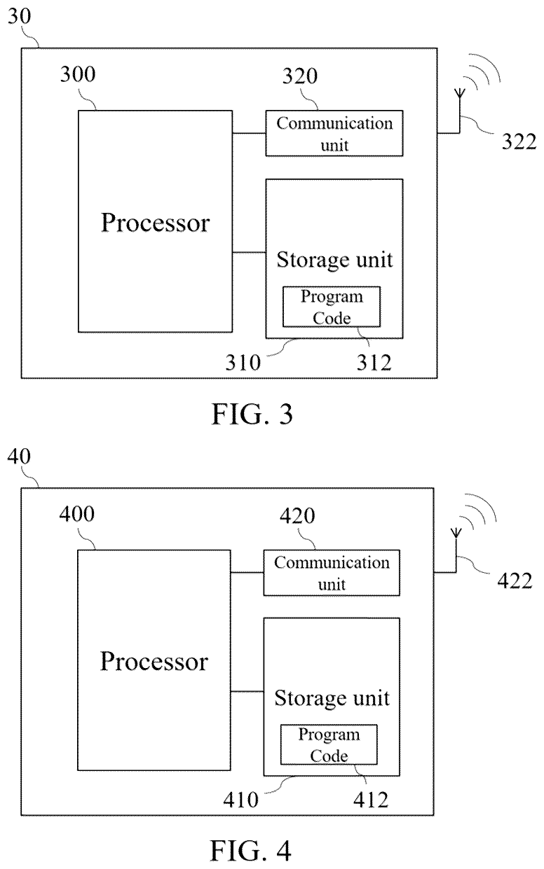

FIG. 3 relates to a schematic diagram of a wireless terminal 30 according to an embodiment of the present disclosure. The wireless terminal 30 may be a user equipment (UE), a mobile phone, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 310 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

FIG. 4 relates to a schematic diagram of a wireless network node 40 according to an embodiment of the present disclosure. The wireless network node 40 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 40 may comprise (perform) at least one network function such as an access and mobility management function (AMF), a session management function (SMF), a user place function (UPF), a policy control function (PCF), an application function (AF), etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 410 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

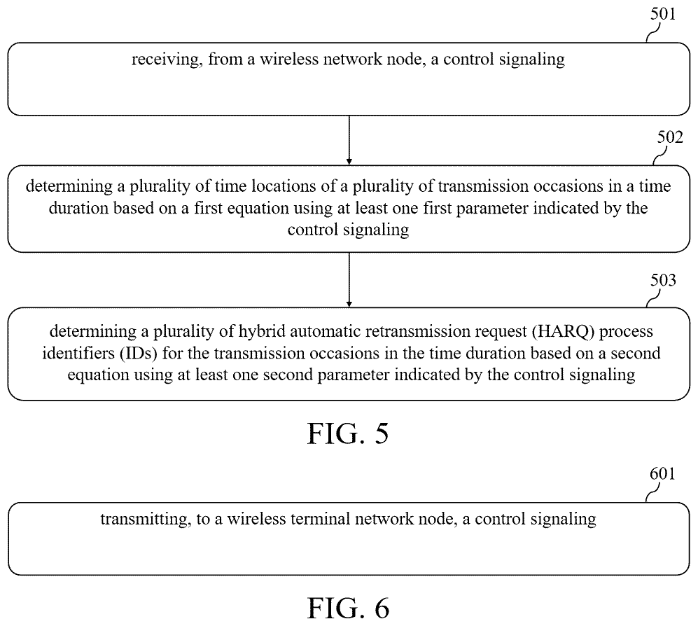

FIG. 5 shows a flow chart of a method according to an embodiment.

An embodiment of the present disclosure relates to wireless communication method for use in a wireless terminal, the method comprising:
Step 501: receiving, from a wireless network node, a control signaling,
Step 502: determining a plurality of time locations of a plurality of transmission occasions in a time duration based on a first equation using at least one first parameter indicated by the control signaling, and
Step 503: determining a plurality of hybrid automatic retransmission request (HARQ) process identifiers (IDs) for the transmission occasions in the time duration based on a second equation using at least one second parameter indicated by the control signaling.

In an embodiment, the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

In an embodiment, the CG list includes at least one of: one or more CG configurations.

In an embodiment, the HARQ process ID pattern pool includes one or more HARQ process ID patterns and the HARQ process ID pattern includes one or more HARQ process IDs.

In an embodiment, the resource location information is used for determining the time locations of the transmission occasions in the time duration.

In an embodiment, the resource location information includes at least one of: a length of the time duration, the time location information of the transmission occasions in the time duration, or a number of the transmission occasions.

In an embodiment, the periodicity information is used for determining at least one of a length of the time duration, a first interval between two consecutive time durations, a second interval between 1st transmission occasions within two consecutive time durations, a third interval between two consecutive transmission occasions in the time duration, or a fourth interval between 1st symbols within two consecutive transmission occasions.

In an embodiment, the time offset information includes a set of time offsets corresponding to the CG list,

In an embodiment, a time unit of the time duration is one of a symbol, a slot, milliseconds, or a radio frame.

In an embodiment, the transmission occasions are for a configured grant transmission.

In an embodiment, the transmission occasions within two consecutive time durations of the configured grant transmission are periodical.

In an embodiment, a repetition for the configured grant transmission is available if a value of a repetition parameter for the repetition is not larger than a value associated with the third interval between two consecutive transmission occasions in the time duration.

In an embodiment, a repetition for the configured grant transmission is available if a value of a repetition parameter for the repetition is not larger than a value associated with a length of the time duration.

In an embodiment, a repetition is unavailable for the configured grant transmission.

In an embodiment, a configured grant based multiple transmit/receive point (mTRP) physical uplink shared channel (PUSCH) repetition is triggered by a plurality of parameter fields in the control signaling.

In an embodiment, the parameter fields comprise at least one of: power control information, power control loop information, path loss reference information, sounding reference signal (SRS) resource information, precoding and multiple-input-multiple-output layer information, or redundancy version information.

In an embodiment, the at least one first parameter comprises at least one of: a periodicity parameter, an offset parameter, a quantity parameter for a number of transmission occasions in the time duration, an index parameter, a system configuration parameter, or a start time parameter.

In an embodiment, the index parameter is associated with an index for one of the transmission occasions, for the time duration or for 1st transmission occasion in the time duration.

In an embodiment, the system configuration parameter indicates at least one of a number of slots in one radio frame, a number of symbols in a radio frame or an index of a staring radio frame of the time duration.

In an embodiment, the start time parameter indicates at least one of a radio frame, a slot or a symbol of a 1st transmission occasion in the time duration.

In an embodiment, the at least one first parameter comprises the periodicity parameter, the index parameter, the system configuration parameter, and the start time parameter.

In an embodiment, the index parameter is associated with an index for the time duration or 1st transmission occasion in the time duration.

In an embodiment, the at least one first parameter comprises the resource location information, the periodicity parameter, the quantity parameter, the time offset parameter, the index parameter, the system configuration parameter, and the start time parameter.

In an embodiment, the quantity parameter is determined based on at least one of resource location information or periodicity information comprised in the control signaling.

In an embodiment, the resource location information includes the time location information of the transmission occasions in the time duration by using a bitmap and the quantity parameter is a number of bits ‘1’ within the bitmap.

In an embodiment, the resource location information includes the time location information of the plurality of transmission occasions in the time duration by using a length of the transmission occasions and the quantity parameter is the length of the transmission occasions.

In an embodiment, the resource location information includes a number of the transmission occasions and the quantity parameter is the number of the transmission occasions.

In an embodiment, the periodicity information includes at least one of a length of the time duration, a third interval between two consecutive transmission occasions in the time duration, or a fourth interval between 1st symbols within two consecutive transmission occasions.

In an embodiment, the quantity parameter is the length of the time duration dividing the third interval or the fourth interval.

In an embodiment, the periodicity information includes a first interval between two consecutive time durations, a second interval between 1st transmission occasions within two consecutive time durations.

In an embodiment, the periodicity parameter is determined based on one of the first interval or the second interval, the index information and the quantity information comprised in the control signaling.

In an embodiment, the time offset parameter is determined based on at least one of the resource location information, the periodicity information or the time offset information comprised in the control signaling.

In an embodiment, the resource location information includes the time location information of the transmission occasions in the time duration by using a bitmap.

In an embodiment, the time offset parameter is a set of bit distances between a 1st bit and each bit having the same value of the 1st bit in the bitmap.

In an embodiment, the resource location information includes the time location information of the transmission occasions in the time duration by using a length of the transmission occasions.

In an embodiment, the time offset parameter is a number of offsets ranging from 0 to the length of the transmission occasions minus 1.

In an embodiment, the resource location information includes the number of the transmission occasions.

In an embodiment, the time offset parameter is a number of offsets ranging from 0 to the number of the transmission occasions minus 1.

In an embodiment, the periodicity information includes at least one of a length of the time duration, a third interval between two consecutive transmission occasions in the time duration, or a fourth interval between 1st symbols within two consecutive transmission occasions.

In an embodiment, the time offset parameter is determined based on the number of transmission occasions, the index information and one of the third interval or the fourth interval.

In an embodiment, the time offset information includes a set of time offsets corresponding to a CG list.

In an embodiment, the time offset parameter is determined based on the set of time offsets.

In an embodiment, the start time parameter is determined by time offset information comprised in the control signaling.

In an embodiment, the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

In an embodiment, the at least one second parameter comprises the parameter associated with the number of the HARQ Process IDs and the time locations of the transmission occasions determined based on the first equation.

In an embodiment, the at least one second parameter comprises the parameter associated with a number of HARQ Process IDs, the periodicity parameter, the offset parameter and the time locations of the transmission occasions determined based on the first equation.

In an embodiment, a number of HARQ process IDs are associated with the quantity parameter for the number of the transmission occasions.

In an embodiment, the periodicity parameter is determined based on periodicity information comprised in the control signaling.

In an embodiment, the periodicity information includes a first interval between two consecutive time durations, or a second interval between 1st transmission occasions within two consecutive time durations.

In an embodiment, the periodicity parameter is the first interval or the second interval.

In an embodiment, the periodicity information includes a third interval between two consecutive transmission occasions in the time duration, or a fourth interval between 1st symbols within two consecutive transmission occasions.

In an embodiment, the periodicity parameter is the third interval or the fourth interval.

In an embodiment, the offset parameter is determined based on at least one of resource location information, periodicity information or the time offset information comprised in the control signaling.

In an embodiment, the resource location information includes the time location of the transmission occasions in the time duration by using a bitmap.

In an embodiment, the offset parameter is determined based on a set of bit distances between a 1st bit and other bits having the same value with the 1st bit within the bitmap.

In an embodiment, the resource location information includes the length of the transmission occasions.

In an embodiment, the offset parameter is determined as a number of offsets ranging from 0 to the length of the transmission occasions minus 1.

In an embodiment, the resource location information includes the number of the transmission occasions.

In an embodiment, the offset parameter is determined as a number of offsets ranging from 0 to the number of the transmission occasions minus 1.

In an embodiment, the periodicity information includes at least one of a length of the time duration, a third interval between two consecutive transmission occasions in the time duration, or a fourth interval between 1st symbols within two consecutive transmission occasions.

In an embodiment, the offset parameter is determined based on the number of transmission occasions, the index information and one of the third interval or the fourth interval.

In an embodiment, the time offset information includes a set of time offsets corresponding to a CG list.

In an embodiment, the offset parameter is determined based on the set of time offsets.

In an embodiment, determining the HARQ process IDs for the transmission occasions in the time duration based on the second equation using the at least one second parameter indicated by the control signaling comprises:
determining a first HARQ process ID for of 1st transmission occasion in the time duration based on the second equation using the at least one second parameter indicated by the control signaling, and
determining the HARQ process IDs of the remaining transmission occasions in the time duration based on the first HARQ process ID.

In an embodiment, the HARQ process IDs of the remaining transmission occasions in the time duration are determined to be equal to the first HARQ process ID, or the HARQ process IDs of the remaining transmission occasions in the time duration are determined to be in an increasing order which is in time domain and starts from the first HARQ process ID.

FIG. 6 shows a flow chart of a method according to an embodiment.

An embodiment of the present disclosure further relates to a wireless communication method for use in a wireless network node, the method comprising:
Step 601: transmitting, to a wireless terminal network node, a control signaling,
wherein the control signaling comprises at least one first parameter used for determining a plurality of time locations of a plurality of transmission occasions in a time duration based on a first equation, and
wherein the control signaling comprises at least one second parameter used for determining a plurality of hybrid automatic retransmission request (HARQ) process identifiers (IDs) for the transmission occasions in the time duration based on a second equation.

In an embodiment, the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

In an embodiment, the CG list includes at least one of: one or more CG configurations.

In an embodiment, the HARQ process ID pattern pool includes one or more HARQ process ID patterns and the HARQ process ID pattern includes one or more HARQ process IDs.

In an embodiment, the resource location information is used for determining the time locations of the transmission occasions in the time duration.

In an embodiment, the resource location information includes at least one of: a length of the time duration, the time location information of the transmission occasions in the time duration, or a number of the transmission occasions.

In an embodiment, the periodicity information is used for determining at least one of a length of the time duration, a first interval between two consecutive time durations, a second interval between 1st transmission occasions within two consecutive time durations, a third interval between two consecutive transmission occasions in the time duration, or a fourth interval between 1st symbols within two consecutive transmission occasions.

In an embodiment, the time offset information includes a set of time offsets corresponding to the CG list.

In an embodiment, a time unit of the time duration is one of a symbol, a slot, milliseconds, or a radio frame.

In an embodiment, the transmission occasions are for a configured grant transmission.

In an embodiment, the transmission occasions within two consecutive time durations of the configured grant transmission are periodical.

In an embodiment, a repetition for the configured grant transmission is available if a value of a repetition parameter for the repetition is not larger than a value associated with an interval between two consecutive transmission occasions in the time duration.

In an embodiment, a repetition for the configured grant transmission is available if a value of a repetition parameter for the repetition is not larger than a value associated with a length of the time duration.

In an embodiment, a repetition is unavailable for the configured grant transmission.

In an embodiment, a configured grant based multiple transmit/receive point (mTRP) physical uplink shared channel (PUSCH) repetition is triggered by a plurality of parameter fields in the control signaling.

In an embodiment, the parameter fields comprise at least one of: power control information, power control loop information, path loss reference information, sounding reference signal (SRS) resource information, precoding and multiple-input-multiple-output layer information, or redundancy version information.

In an embodiment, the at least one first parameter comprises at least one of: a periodicity parameter, an offset parameter, a quantity parameter for a number of transmission occasions in the time duration, an index parameter, a system configuration parameter, or a start time parameter.

In an embodiment, the index parameter is associated with an index for one of the transmission occasions, for the time duration or for 1st transmission occasion in the time duration.

In an embodiment, the system configuration parameter indicates at least one of a number of slots in one radio frame, a number of symbols in a radio frame or an index of a staring radio frame of the time duration.

In an embodiment, the start time parameter indicates at least one of a radio frame, a slot or a symbol of a 1st transmission occasion in the time duration.

In an embodiment, the at least one first parameter comprises the periodicity parameter, the index parameter, the system configuration parameter, and the start time parameter.

In an embodiment, the index parameter is associated with an index for the time duration or 1st transmission occasion in the time duration.

In an embodiment, the at least one first parameter comprises the resource location information, the periodicity parameter, the quantity parameter, the time offset parameter, the index parameter, the system configuration parameter, and the start time parameter.

In an embodiment, the quantity parameter is determined based on at least one of resource location information or periodicity information comprised in the control signaling.

In an embodiment, the resource location information includes the time location information of the transmission occasions in the time duration by using a bitmap and the quantity parameter is a number of bits ‘1’ within the bitmap.

In an embodiment, the resource location information includes the time location information of the plurality of transmission occasions in the time duration by using a length of the transmission occasions and the quantity parameter is the length of the transmission occasions.

In an embodiment, the resource location information includes a number of the transmission occasions and the quantity parameter is the number of the transmission occasions.

In an embodiment, the periodicity information includes at least one of a length of the time duration, a third interval between two consecutive transmission occasions in the time duration, or a fourth interval between 1st symbols within two consecutive transmission occasions.

In an embodiment, the quantity parameter is the length of the time duration dividing the third interval or the fourth interval.

In an embodiment, the periodicity information includes a first interval between two consecutive time durations, a second interval between 1st transmission occasions within two consecutive time durations.

In an embodiment, the periodicity parameter is determined based on one of the first interval or the second interval, the index information and the quantity information comprised in the control signaling.

In an embodiment, the time offset parameter is determined based on at least one of the resource location information, the periodicity information or the time offset information comprised in the control signaling.

In an embodiment, the resource location information includes the time location information of the transmission occasions in the time duration by using a bitmap.

In an embodiment, the time offset parameter is a set of bit distances between a 1st bit and each bit having the same value of the 1st bit in the bitmap.

In an embodiment, the resource location information includes the time location information of the transmission occasions in the time duration by using a length of the transmission occasions.

In an embodiment, the time offset parameter is a number of offsets ranging from 0 to the length of the transmission occasions minus 1.

In an embodiment, the resource location information includes the number of the transmission occasions.

In an embodiment, the time offset parameter is a number of offsets ranging from 0 to the number of the transmission occasions minus 1.

In an embodiment, the periodicity information includes at least one of a length of the time duration, a third interval between two consecutive transmission occasions in the time duration, or a fourth interval between 1st symbols within two consecutive transmission occasions.

In an embodiment, the time offset parameter is determined based on the number of transmission occasions, the index information and one of the third interval or the fourth interval.

In an embodiment, the time offset information includes a set of time offsets corresponding to a CG list.

In an embodiment, the time offset parameter is determined based on the set of time offsets.

In an embodiment, the start time parameter is determined by time offset information comprised in the control signaling.

In an embodiment, the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

In an embodiment, the at least one second parameter comprises the parameter associated with the number of the HARQ Process IDs and the time locations of the transmission occasions determined based on the first equation.

In an embodiment, the at least one second parameter comprises the parameter associated with a number of HARQ Process IDs, the periodicity parameter, the offset parameter and the time locations of the transmission occasions determined based on the first equation.

In an embodiment, a number of HARQ process IDs are associated with the quantity parameter for the number of the transmission occasions.

In an embodiment, the periodicity parameter is determined based on periodicity information comprised in the control signaling.

In an embodiment, the periodicity information includes a first interval between two consecutive time durations, or a second interval between 1st transmission occasions within two consecutive time durations.

In an embodiment, the periodicity parameter is the first interval or the second interval.

In an embodiment, the periodicity information includes a third interval between two consecutive transmission occasions in the time duration, or a fourth interval between 1st symbols within two consecutive transmission occasions.

In an embodiment, the periodicity parameter is the third interval or the fourth interval.

In an embodiment, the offset parameter is determined based on at least one of resource location information, periodicity information or the time offset information comprised in the control signaling.

In an embodiment, the resource location information includes the time location of the transmission occasions in the time duration by using a bitmap.

In an embodiment, the offset parameter is determined based on a set of bit distances between a 1st bit and other bits having the same value with the 1st bit within the bitmap.

In an embodiment, the resource location information includes the length of the transmission occasions.

In an embodiment, the offset parameter is determined as a number of offsets ranging from 0 to the length of the transmission occasions minus 1.

In an embodiment, the resource location information includes the number of the transmission occasions.

In an embodiment, the offset parameter is determined as a number of offsets ranging from 0 to the number of the transmission occasions minus 1.

In an embodiment, the periodicity information includes at least one of a length of the time duration, a third interval between two consecutive transmission occasions in the time duration, or a fourth interval between 1st symbols within two consecutive transmission occasions.

In an embodiment, the offset parameter is determined based on the number of transmission occasions, the index information and one of the third interval or the fourth interval.

In an embodiment, the time offset information includes a set of time offsets corresponding to a CG list.

In an embodiment, the offset parameter is determined based on the set of time offsets.

An embodiment of the present disclosure further relates to a wireless terminal 30, comprising:
a communication unit 320, configured to receive, from a wireless network node 40, a control signaling, and
a processor 300, configured to:
determine a plurality of time locations of a plurality of transmission occasions in a time duration based on a first equation using at least one first parameter indicated by the control signaling, and
determine a plurality of hybrid automatic retransmission request (HARQ) process identifiers (IDs) for the transmission occasions in the time duration based on a second equation using at least one second parameter indicated by the control signaling.

According to various embodiments, the processor 300 is further configured to perform the wireless communication method described above.

An embodiment of the present disclosure further relates to a wireless network node 40, comprising:
a communication unit 420, configured to transmit, to a wireless terminal 30, a control signaling,
wherein the control signaling comprises at least one first parameter used for determining a plurality of time locations of a plurality of transmission occasions in a time duration based on a first equation, and
wherein the control signaling comprises at least one second parameter used for determining a plurality of hybrid automatic retransmission request (HARQ) process identifiers (IDs) for the transmission occasions in the time duration based on a second equation.

According to various embodiments, the wireless network node further comprises a processor 400 further configured to perform the wireless communication method described above.

An embodiment of the present disclosure relates to a computer program product comprising a computer-readable program medium code stored thereupon, the code, when executed by a processor, causing the processor to implement a wireless communication method recited in any one of foregoing methods.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a wireless terminal, the wireless communication method comprising:
receiving, from a wireless network node, a control signaling,
determining a plurality of time locations of a plurality of transmission occasions in a time duration based on a first equation using at least one first parameter indicated by the control signaling, where the transmission occasions are for configured grant transmission, wherein a time unit of the time duration is one of a symbol, slot, milliseconds or a radio frame, wherein the transmission within two consecutive time durations of the configured grant transmission are periodical, and
determining a plurality of hybrid automatic retransmission request (HARQ) process identifiers (IDs) for the transmission occasions in the time duration based on a second equation using at least one second parameter indicated by the control signaling,
wherein a first HARQ process ID for the first transmission occasion in the time duration is determined by the second equation and determining the HARQ process IDs of the remaining transmission occasions in the time duration are determined to be in an increasing order which is in time domain and starts from the first HARQ process ID.

2. The wireless communication method of claim 1, wherein the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

3. The wireless communication method of claim 2, wherein the resource location information is used for determining the time locations of the transmission occasions in the time duration, wherein the resource location information includes at least one of: a length of the time duration, the time location information of the transmission occasions in the time duration, or a number of the transmission occasions.

4. The wireless communication method of claim 2, wherein the periodicity information is used for determining at least one of a length of the time duration, a first interval between two consecutive time durations, a second interval between 1st transmission occasions within two consecutive time durations, a third interval between two consecutive transmission occasions in the time duration, or a fourth interval between 1st symbols within two consecutive transmission occasions.

5. The wireless communication method of claim 1, wherein a repetition is unavailable for the configured grant transmission.

6. The wireless communication method of claim 1, wherein the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

7. The wireless communication method of claim 6, wherein the at least one second parameter comprises the parameter associated with the number of the HARQ Process IDs and the time locations of the transmission occasions determined based on the first equation.

8. The wireless communication method of claim 6, wherein the at least one second parameter comprises the parameter associated with a number of HARQ Process IDs, the periodicity parameter, the offset parameter and the time locations of the transmission occasions determined based on the first equation.

9. The wireless communication method of claim 6, wherein a number of HARQ process IDs are associated with a quantity parameter for the number of the transmission occasions.

10. The wireless communication method of claim 6, wherein the periodicity parameter is determined based on periodicity information comprised in the control signaling.

11. The wireless communication method of claim 10, wherein the periodicity information includes a first interval between two consecutive time durations, or a second interval between 1st transmission occasions within two consecutive time durations,
wherein the periodicity parameter is the first interval or the second interval.

12. A wireless communication method for use in a wireless network node, the wireless communication method comprising:
transmitting, to a wireless terminal network node, a control signaling,
wherein the control signaling comprises at least one first parameter used for determining a plurality of time locations of a plurality of transmission occasions in a time duration based on a first equation, where the transmission occasions are for configured grant transmission, wherein a time unit of the time duration is one of a symbol, slot, milliseconds or a radio frame, wherein the transmission within two consecutive time durations of the configured grant transmission are periodical, and
wherein the control signaling comprises at least one second parameter used for determining a plurality of hybrid automatic retransmission request (HARQ) process identifiers (IDs) for the transmission occasions in the time duration based on a second equation.

13. The wireless communication method of claim 12, wherein the control signaling comprises at least one of resource location information, periodicity information, time offset information, scheduling information associated with the plurality of transmission occasions in the time duration, a configured grant (CG) list, or a HARQ process ID pattern pool for the plurality of transmission occasions.

14. The wireless communication method of claim 13, wherein the resource location information is used for determining the time locations of the transmission occasions in the time duration, wherein the resource location information includes at least one of: a length of the time duration, the time location information of the transmission occasions in the time duration, or a number of the transmission occasions.

15. The wireless communication method of claim 13, wherein the periodicity information is used for determining at least one of a length of the time duration, a first interval between two consecutive time durations, a second interval between 1^{st} transmission occasions within two consecutive time durations, a third interval between two consecutive transmission occasions in the time duration, or a fourth interval between 1^{st} symbols within two consecutive transmission occasions.

16. The wireless communication method of claim 13, wherein the time offset information includes a set of time offsets corresponding to the CG list.

17. The wireless communication method of claim 12, wherein a repetition is unavailable for the configured grant transmission.

18. The wireless communication method of claim 12, wherein the at least one second parameter comprises at least one of a parameter associated with a number of HARQ Process IDs in the time duration, a periodicity parameter, an offset parameter, the time location of the transmission occasions determined based on the first equation, or an entry for indicating a HARQ process ID pattern for the transmission occasions.

19. A wireless terminal, comprising:
a communication unit, configured to receive, from a wireless network node, a control signaling, and
at least one processor, configured to:
determine a plurality of time locations of a plurality of transmission occasions in a time duration based on a first equation using at least one first parameter indicated by the control signaling, and
determine a plurality of hybrid automatic retransmission request (HARQ) process identifiers (IDs) for the transmission occasions in the time duration based on a second equation using at least one second parameter indicated by the control signaling.

20. A wireless network node, comprising:
a communication unit, and
a processor configured to perform the method of claim 12.
